(19) United States
(12) Patent Application Publication
(10) Pub. No.: US 2008/0038491 A1
(43) Pub. Date: Feb. 14, 2008

(54) Method for Producing Ink Jet Recording Sheet and Ink Jet Recording Sheet

(75) Inventors: Kazuo Ikeda, Yokohama-shi (JP); Motoko Hiraki, Warabi-shi (JP); Shinichi Asano, Tokyo (JP); Tomoyuki Hisaoka, Chiba-shi (JP); Nobuhisa Dano, Chiba-shi (JP); Hiroyuki Nemoto, Ichihara-shi (JP)

Correspondence Address: KNOBBE MARTENS OLSON & BEAR LLP, 2040 MAIN STREET, FOURTEENTH FLOOR, IRVINE, CA, 92614, US

(73) Assignee: OJI PAPER CO., LTD., Tokyo (JP)

(21) Appl. No.: 11/574,970

(22) PCT Filed: Sep. 8, 2005
(86) PCT No.: PCT/JP05/16528

§ 371 Date: Mar. 8, 2007

(30) Foreign Application Priority Data
Sep. 9, 2004 (JP) 2004-262003
Nov. 24, 2004 (JP) 2004-338553

(51) Int. Cl. B41M 5/50; B41J 2/01; B41M 5/52; B41M 5/00

(52) U.S. Cl. 428/32.25; 427/372.2; 428/32.26

(57) ABSTRACT

The present invention relates to a method for producing an ink jet recording sheet characterized by including: applying a coating liquid containing at least both a temperature-sensitive polymeric compound and a pigment the temperature-sensitive polymeric compound having a temperature region where hydrophobicity is exhibited and a temperature region where hydrophilicity is exhibited, the coating liquid becoming more viscous or gelating in the temperature region where hydrophilicity is exhibited, onto either an air-permeable support or at least one undercoating layer provided on an air-permeable support in the temperature region where hydrophobicity is exhibited, to form a coating layer of the coating liquid, bringing the temperature thereof to the temperature region where the temperature-sensitive polymeric compound exhibits hydrophilicity to increase the viscosity of the coating layer or gelate the coating layer, then applying a wetting liquid containing an ink fixing agent (and colloidal particles) onto the viscosity-increased or gelated coating layer, followed by bringing the assembly into contact and press to a heated specular surface and drying to form an ink-receptive layer.

### TECHNICAL FIELD

The present invention relates to a method for producing an ink jet recording sheet and the ink jet recording sheet.

The present invention claims priority of Japanese Patent Application No. 2004-262003 filed on Sep. 9, 2004, and of Japanese Patent Application No. 2004-338553 filed on Nov. 24, 2004, the contents of which are incorporated herein by reference.

### BACKGROUND ART

A casting method is known as a method for producing printing paper with glossiness, in which a coating liquid containing a pigment and the like is applied to form a coating layer onto an air-permeable support, the coating layer in a wet state or a rewet state is brought into contact and press to a heated drum with a specular surface and dried to copy the specular surface. The printing paper produced in accordance with the casting method has high surface glossiness and excellent surface smoothness, and exhibits excellent printing effects, in comparison with other coated sheets, and thereby is mainly used for producing high-grade printed matter.

Conventional cast methods are as follows: (1) a wet casting method in which a coating liquid is applied on a base paper, and then immediately, while the coating liquid is in a wet states the assembly is brought into contact and press to a casting drum; (2) a precasting method in which a coating liquid is directly applied on a casting drum and dried, and then the dried coating layer is pressed to transfer onto a base paper; (3) a gelation casting method (circumstantially referred to as an acid gelation method, a salt gelation method, or a thermal gelation method) in which a coating liquid is applied on a base paper, and then gelated by adding an acid or salt, or heating, and the gelated coating layer is brought into contact and press to a casting drum; (4) a rewet casting method in which a coating liquid is applied on a base paper and dried to form a coating layer, and the coating layer is wetted again to be plasticized, and then is brought into contact and press to a casting drum; and (5) a dry casting method in which, unlike the rewet casting method, a coating layer formed by applying and drying a coating liquid is brought into contact and press to a high-temperature casting drum in a dry state without being rewetted (see, for example, Non-patent document 1).

Meanwhile, an ink jet printer is able to record with low noise at a high-speed and easily to form multi colors and so is used in many fields. An ink jet recording sheet is required to have high ink-absorbability so as to realize high-speed and multicolor ink-jet-recording. Accordingly, in recent years, as an ink jet recording sheet a high-quality paper designed to mainly enhance the ink-absorbability, a coated sheet of which surface is coated with a porous pigment, or the like has been used.

However, most of these conventional ink jet recording sheets are matted to decrease the surface glossiness, so the appearance thereof is not good. Accordingly, an ink jet recording sheet with high surface glossiness and excellent appearance is required, and an ink jet recording sheet produced with a cast-coating method has been proposed.

For example, an ink jet recording cast-coated paper has been proposed, the cast-coated paper being produced by a wet casting method in which a recording layer including a pigment and adhesive as the main component thereof is formed on a base paper, on which a cast coating layer is formed by applying a coating liquid mainly containing a copolymer with a glass-transition point of 40° C. or higher, the copolymer being produced by polymerizing a monomer having an ethylenically unsaturated bond, and then the cast coating layer is brought into contact and press to a heated specular drum, while the layer is in a wet state, to realize excellent glossiness and ink-absorbability (see, for example, Patent document 1).

Also, an ink jet recoding sheet produced by a coagulating-type casting method (alternatively, referred to as gelation casting method) has been produced in which a coating liquid containing a pigment and adhesive is applied on one surface of an air-permeable support, a coagulant which is coagulable with the adhesive is further applied and the resultant in a wet state is brought into contact and press to a casting drum (see, for example, Patent document 2).

Moreover, an ink jet recording sheet with glossy texture has been proposed, the sheet being produced by a rewet casting method in which a coating liquid containing a pigment and adhesive is applied on one surface of an air-permeable support, the coating layer is dried, the coating layer is wetted again using a wetting liquid, and is brought into contact and press to a casting drum (see, for example, Patent document 3).

Moreover, in addition to the casting methods, a method for smoothing the surface of a coating layer by passing a sheet between pressurized or heated rolls using a calender such as a supercalender, gloss calender, or the like, is known as a method for imparting glossiness to a recording sheet.

In recent years, a polymeric emulsion containing a polymeric compound produced by conducting polymerization in the coexistence of polyvinyl alcohol and/or polyvinyl alcohol derivatives, the polymeric compound exhibiting hydrophilicity at a fixed temperature (temperature-sensitive point) or lower, but exhibiting hydrophobicity at a temperature higher than the temperature-sensitive point, and a recording medium in which a coating layer is formed using this polymeric emulsion have been proposed (see, for example, Patent document 4).

Meanwhile, a recording sheet produced by a rewet casting method in which the sheet is treated with a rewetting liquid containing a cationic resin has been proposed (see, for example, Patent document 5).
Non-patent document 1: Pulp and paper manufacturing technology, series 8, Coating (pages 269 to 282).
Patent document 1: Japanese Unexamined Patent Application, First Publication No. H 7-89220.
Patent document 2. Japanese Laid-open Patent Application No. 2002-166644.
Patent document 3: Japanese Examined Patent Application, Second Publication No. H 7-96331.
Patent document 4: Japanese Laid-open Patent Application No 2003-40916.
Patent document 5: Japanese Unexamined Patent Application, First Publication No. H 6-3052387.

### DISCLOSURE OF THE INVENTION

[Problems to be Solved by the Invention]

However, in recent years, an ink jet recording medium that can exhibit higher printing density, and superior brightness, recording suitability such as preventability of print bleeding, recording suitability when using with a pigment ink, and glossiness, than ever before, has been required. However, conventional recording mediums do not meet all the demands.

That is, the ink jet recording sheet produced by the wet casting method as disclosed in Patent document 1 realizes sufficient ink-absorbability, but tends to lack glossiness due to insufficient surface smoothness and be inferior in printability such as ink-dot roundness, in comparison to an ink jet recording medium using a printing paper substrate.

In the case of the gelation cast method as disclosed in Patent document 2, since the solid content of the coating liquid to be gelated is less than 5% by mass, the moisture content of the coating layer becomes extremely high, which causes lowered dying efficiency, cracking of the coating layer, and insufficient gelation control which causes unevenness when solid-printing is conducted. Moreover, the gelation casting method requires two coating steps using the coating liquid containing a pigment and an adhesive and the coating liquid containing a coagulant, and causes a problem in which a uniform coating layer cannot be formed due to an uneven coating amount of the coagulant. Accordingly, it is difficult in actuality for ink jet recording sheets of the same quality to be provided by the gelation method.

In the case of the rewet casting method as disclosed in Patent document 3, since the coating layer is once dried, the degree of plasticization of the coating layer is significantly low in comparison with other casting methods (such as a wet casting method or gelation casting method), and there is a case in which uneven plasticization is caused. Thus, it is difficult to produce an even and favorable coating surface. Accordingly, it is difficult in actuality to provide an ink jet recording sheet which can realize high printing quality approximately at the same level as conventional photographic image quality realized by the rewet casting method.

When an ink jet recording sheet is produced in accordance with the method for smoothing the surface of the coating layer by passing the sheet between pressurized or heated rolls using a calender such as a supercalender, gloss calender, or the like, the glossiness is improved by conducting the calendering process under a large linear pressure to impart the glossiness, but the ratio of air gaps in the coating layer is decreased, and thereby the rate of ink-absorption is slowed, and also the capacity of ink-absorption is decreased. As a result, ink overflows without being absorbed in the ink-receptive layer after printing, and thereby deterioration of printability, such as bleeding of printed matter or deteriorated uniformity of solid parts, is caused. Accordingly, it is required to conduct We calendering process under a low linear pressure so as to ensure the ink-absorbability required for ink jet recording. Thus, it is difficult to produce an ink jet recording sheet realizing both the printability and glossiness, both being required for ink jet recording.

Although Patent Document 4 discloses the use of the temperature-sensitive polymeric compound for the recording layer, the document does not disclose specific procedures for improving the glossiness of a recording sheet or the like.

Although Patent document 5 discloses the use of the cationic resin for the wetting liquid in the rewet casting method, the use of the cationic resin for the wetting liquid deteriorates the glossiness probably due to there being no temperature-sensitive polymeric compounds present (Patent document 5, Example 1 and Comparative example 1).

The present invention has been achieved in view of the above-mentioned circumstances, and provides a novel method for producing an ink jet recording sheet. A thus produced ink jet recording sheet is excellent in glossiness, recording suitability such as ink-bleeding, or the like, and recording suitability when using with a pigment ink, and realizes high printing density, as a result of which colors of printed images are bright, and so is an extremely and highly practical ink jet recording sheet.

[Means for Solving the Problems]

(1) The present invention provides a method for producing an ink jet recording sheet characterized by including; applying a coat liquid containing at least both a temperature-sensitive polymeric compound and a pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity, onto either an air-permeable support or at least one undercoating layer provided on the air-permeable support, in the temperature region where the temperature-sensitive polymeric compound exhibits hydrophobicity, to form a coating layer of the coating liquid; bringing a temperature of the coating layer to the temperature region where the temperature-sensitive polymeric compound exhibits hydrophilicity to increase the viscosity of the coating layer or gelate the coating layer; then applying a wetting liquid containing an ink fixing agent onto the viscosity-increased or gelated coating layer; followed by bringing the assembly into contact and press to a heated specular surface and drying to form an ink-receptive layer.
(2) In the method for producing an ink jet recording sheet according to (1), at least 75% by mass of the whole ink fixing agent contained in the ink jet recording sheet is provided by the wetting liquid.
(3) In the method for producing an ink jet recording sheet according to (1) or (2), a moisture content of the coating layer at a time of applying the wetting liquid is greater than or equal to 12% by mass.
(4) In the method for producing an ink jet recording sheet according to any one of (1) to (3), the undercoating layer is provided on the air-permeable support and the undercoating layer contains a pigment having an average particle diameter of 1 to 12 μm.
(5) In the method for producing an ink jet recording sheet according to any one of (1) to (4), the ink fixing agent contained in the wetting liquid contains at least one selected from the group consisting of a diallyl dimethyl ammonium chloride polymer, a diallyl dimethyl ammonium chloride-acrylamide copolymer, a hydrochloride salt of an acrylamide-diallylamine copolymer, a dicyandiamide-polyethyleneamine copolymers and a cationic resin having a five-membered cyclic amidine structure.
(6) The present invention provides a method for producing an ink jet recording sheet characterized by including: applying a coating liquid containing at least both a temperature-sensitive polymeric compound and a pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity, onto either an air-permeable support or at least one undercoating layer provided on the air-permeable support, in the temperature region where the temperature-sensitive polymeric compound exhibits hydrophobicity, to form a coating layer of the coating liquid; bringing a temperature of the coating layer to the temperature region where the temperature-sensitive polymeric compound exhibits hydrophilicity to increase the viscosity of the coating layer or to gelate the coating layer; drying to form an ink-receptive layer; applying a surface layer-wetting coating liquid containing colloidal particles and an ink fixing agent onto the ink-receptive layer; followed by bringing the assembly into contact and press to a heated specular surface and drying to form a surface layer.
(7) In the method for producing an ink jet recording sheet according to (6), at least 75% by mass of the whole ink fixing agent contained in the ink jet recording sheet is provided by the surface layer-wetting coating liquid.
(8) in the method for producing an ink jet recording sheet according to (6) or (7), the ink fixing agent contained in the surface layer-wetting coating liquid contains at least one selected from the group consisting of a diallyl dimethyl ammonium chloride polymer, a diallyl dimethyl ammonium chloride-acrylamide copolymer, a hydrochloride salt of an acrylamide-diallylamine copolymer, a dicyandiamide-polyethyleneamine copolymer, and a cationic resin having a five-membered cyclic amidine structure.
(9) In the method for producing an ink jet -recording s according to any one of (6) to (8), the colloidal particles contained in the surface layer-wetting coating liquid are at least one selected from the group consisting of a monodispersed colloidal pigment having an average primary particle diameter of 0.01 to 0.06 μm, an alumna having an average secondary particle diameter of 1 μm or less, an alumina hydrate having an average secondary particle diameter of 1 μm or less, a fumed silica having an average secondary particle diameter of 0.7 μm or less, and a wet-processed silica gel having an average secondary particle diameter of 0.5 μm or less.
(10) In the method for producing an ink jet recording sheet according to any one of (6) to (9), the colloidal particles contained in the surface layer-wetting coating liquid are cationic colloidal silica.
(11) The present invention provides an ink jet recording sheet characterized by including: an ink-receptive layer formed on either an air-permeable support or at least one undercoating layer formed on the air-permeable support, the ink-receptive layer containing a temperature-sensitive polymeric compound having a temperature region where the temperature-sensitive polymeric compound exhibits hydrophobicity and a temperature region where the temperature-sensitive polymeric compound exhibits hydrophilicity, a pigment, and an ink fixing agent, the ink fixing agent being distributed in a manner such that a content of the ink fixing agent decreases from a surface-side of the ink-receptive layer to an air-permeable support-side of the ink-receptive layer.
(12) The ink jet recording sheet according to (11) further includes a surface layer provided on the ink-receptive layer, the surface layer containing an ink fixing agent and colloidal particles.

### EFFECTS OF THE INVENTION

The ink jet recording sheet produced in accordance with the method for producing the same according to the present invention has a high glossiness, exhibits excellent high image density, preventability of print bleeding, ink-dot roundness, and the likes so high-fine images can be printed out. Moreover, the ink jet recording sheet exhibits excellent recording suitability when a pigment ink is used, so has extremely excellent practical usefulness.

### BEST MODE FOR CARRYING OUT THE INVENTION

A first aspect of the present invention provides a method for producing an ink jet recording sheet characterized by applying a coating liquid containing at least both a temperature-sensitive polymeric compound and a pigment, the temperature-sensitive polymeric compound having a temperature region where the temperature-sensitive polymeric compound exhibits hydrophobicity and a temperature region where the temperature- sensitive polymeric compound exhibits hydrophilicity, the coating liquid becoming more viscous or gelating in the temperature region where the temperature-sensitive polymeric compound exhibits hydrophilicity, onto either an air-permeable support or at least one undercoating layer provided on the air-permeable support, in the temperature region where the temperature-sensitive polymeric compound exhibits hydrophobicity, to form a coating layer of the coating liquid; bringing a temperature of the coating layer to the temperature region where the temperature-sensitive polymeric compound exhibits hydrophilicity to increase the viscosity of the coating layer or gelate the coating layer; then applying a wetting liquid containing an ink fixing agent onto the viscosity-increased or gelated coating layer; followed by bringing the assembly into contact and press to a heated specular surface and drying to form an ink-receptive layer.

When printing is conducted using a dye-type ink jet ink onto the ink jet recording sheet produced in accordance with the above method, a printing gains high density, and thus a clear image with bright colors can be printed out. Although the reason for this is not clear, the reason is assumed that by supplying the ink fixing agent using the wetting liquid, large amounts of the ink fixing agent are present near the surface of an ink-receptive side of the recording sheet and the ink fixing agent is present in the ink-receptive layer in such a distribution manner that the content thereof decreases in the thickness direction from the surface of the layer, as a result of which most of an ink dye provided when printing using the dye-type ink jet ink is retained near the surface of the ink-receptive layer. In particular, it is preferable that at least 75% by mass of the whole ink fixing agent contained in the ink-receptive layer be supplied by applying the wetting liquid, because the above-mentioned effects are significantly exhibited. When less than 75% by mass of the whole ink fixing agent is supplied by applying the wetting liquid, most of an ink dye provided when printing using the dye-type ink jet ink tends not to be retained near the surface of the layer, as a result of which the density of printed matter tends to decrease and the brightness of their colors tends to be lost.

Moreover, a second aspect of the present invention provides an ink jet recording sheet characterized by including: an ink-receptive layer formed on either an air-permeable support or at least one undercoating layer formed on the air-permeable support, the ink-receptive layer containing a temperature-sensitive polymeric compound having a temperature region where the temperature-sensitive polymeric compound exhibits hydrophobicity and a temperature region where the temperature-sensitive polymeric compound exhibits hydrophilicity, a pigment, and an ink fixing agent, the ink fixing agent being distributed in a manner such that a content of the ink fixing agent decreases from a surface-side of the ink-receptive layer to an air-permeable support-side of the ink-receptive layer.

Such an ink jet recording sheet can be produced in accordance with the method of the first aspect of the present invention, for example, and has an excellent glossiness, exhibits high printing density when a dye ink is used, prevents occurrence of print bleeding, shows excellent dot roundness, and is also excellent in recording suitability when using a pigment ink.

In the following, components of the first and second aspects of the present invention will be explained in detail.

“Air-Permeable Support”.

The above-mentioned air-permeable support is not particularly limited, provided that it has a gas-permeability, and examples thereof include high-quality paper, art paper, coated paper, cast-coated paper, foil paper, craft paper, baryta paper, paper board, impregnated paper, vapor deposition paper, air-permeable base paper used for a general coated sheet, such as acid paper or neutralized paper, air-permeable resin sheet, and the like. Although there is no particular limitation with respect to the air-permeability, it is preferable that the Ohken-type air-permeability be approximately 10 to 350 seconds, more preferably approximately 10 to 200 seconds, and even more preferably approximately 20 to 100 seconds, in view of workability (ease of permeation of vapor) at a time of cast finishing (bringing the coating layer into contact and press to a heated specular sure) and preventability of infiltration of the coating liquid into the air-permeable support. When the Ohken-type air-permeability is at least 10 seconds, it is possible to prevent the coating liquid from infiltrating in the support or the undercoating layer formed as needed. In contrast, when the Ohken-type air-permeability is 350 seconds or less, it is possible to prevent the workability from deteriorating at a time of bringing the layer into contact and press to a specular roll as described below.

As the air-permeable base paper, those containing a wood pulp as the main component thereof, and additives such as fillers, various auxiliaries, or the like, as needed, can be used.

As the wood pulp, various chemical pulps, mechanical pulps, recycled pulps, or the like, may be used. The beating degree of these pulps may be adjusted using a beating machine so as to adjust the paper strength, papermaking suitability, or the like. The beating degree (freeness) of the pulp is not particularly looted, but is generally approximately 250 to 550 ml (CSF: JIS-P-8121). Although a higher beating degree is preferable to improve the smoothness, there are many cases in which the roughness of the sheet or bleeding of recorded images, both of which being caused by moisture contained in the ink, results in a favorable condition by lowering the beating degree. Accordingly, the freeness range is preferably approximately 300 to 500 ml.

The filler is formulated so as to provide opaqueness or adjust the ink absorbability thereof and examples thereof include calcium carbonate, baked kaolin, silica, titanium oxide, and the like. Since calcium carbonate enhances the whiteness degree of the air-permeable support and glossy texture of the ink jet recording sheet, calcium carbonate is preferably used, in particular. It is preferable that the content of the filler (ash content) in the air-permeable base paper be approximately 1 to 20% by mass. When the content is extremely great, the paper strength may deteriorate. When the content is extremely small, the air-permeability of a paper substrate tends to deteriorate. Accordingly, the content of the filler is more preferably 7 to 20% by mass. When the content is within the range, the smoothness, air-permeability, and paper strength are balanced, and thereby an ink jet recording sheet with excellent glossiness and definition in image tends to be easily produced.

As the auxiliaries, a sizing agent, fixing agent, paper-reinforcing agent, cationizing agent, yield-improving agent, dye, fluorescent whitening agent, or the like may be added. Use of the paper-reinforcing agent such as a polyamide-epichlorohydrin resin, N-vinylformamide-vinylamine copolymer, or the like by adding, applying, or impregnating realizes excellent strength and dimensional stability at a time of applying the coating liquid, and thus is particularly preferable. The polyamide-epichlorohydrin resin can improve the dimensional stability of the paper at a time of applying the coating layer or a wetting liquid, and thus is preferably used, in particular.

Moreover, the surface strength, sizing degree, or the like, may be adjusted in a size press process using a paper making machine by applying or impregnating a starch, a polyvinyl alcohol, a cationic resin, or the like to the air-permeable base paper.

It is preferable that the Stockigt sizing degree of the paper substrate (measured as 100 g/m² paper) be approximately 1 to 250 seconds. When the siring degree is low, there is a case in which operational problems such as generation of wrinkles at a time of application occur. When the sizing degree is high, there is a case in which the ink absorption decreases and curling or cockling occurs significantly after printing. The more preferable sizing degree is within a range from 4 to 120 seconds. Although the base weight of the paper substrate is not particularly limited, the base weight is approximately 20 to 400 g/m².

“Undercoating Layer”.

On the air-permeable support, a single or plural undercoating layer(s) may be formed, as needed. It is preferable that the undercoating flyer be formed, because the glossiness can be improved, when the ink-receptive layer is formed on the undercoating layer. The reason for this is assumed that the presence of the undercoating layer, which is softer than the air-permeable support enhances the adherence to a heated specular surface (such as, for example, a casting drum). Moreover, the undercoating layer contributes to suitably adjust the ink-absorbability, enhance the printing density, and improve recording suitability such as preventability of print bleeding and solid uniformity.

Although components contained in the undercoating layer are not particularly limited, a pigment, which contributes to absorbing ink, and an adhesive, which contributes to fixing the pigment in the air-permeable support, are preferably contained. If needed, an ink fixing agent may be further contained.

The pigment to be contained in the undercoating layer is not particularly limited, and at least one of various pigments well known to be conventionally used for manufacturing general coated sheets, such as a kaolin, clay, baked clay, noncrystalline silica (alternatively, referred to as amorphous silica), synthesized noncrystalline silica, zinc oxide, aluminum oxide, titanium oxide, aluminum hydroxide, calcium carbonate, Satin white, aluminum silicate, alumina, colloidal silica, zeolite, synthesized zeolite, sepiolite, smectite, synthesized smectite, magnesium silicate, magnesium carbonate, magnesium oxide, diatomaceous earth, styrene-based plastic pigment, hydrotalcite, urea resin-based plastic pigment, benzoguanamine-based plastic pigment and the like, may be used alone or in combination. Among these, zinc oxide, titanium oxide, and plastic pigments can prevent white paper from changing into yellow, and thus are preferably formulated. Moreover, amorphous silica, alumina, and zeolite realizes high ink-absorbability, and thus is preferably formulated as the main component.

Although the pigment is not particularly limited in terms of the average particle diameter (average agglomerated particle diameter in the case of agglomerated pigments), it is preferable that the average particle diameter be approximately 1 to 12 μm, more preferably 2 to 10 μm, and even more preferably 2 to 7 μm, from the standpoint of the ink absorbability, and surface smoothness and glossiness of the ink-receptive layer to be formed later, and plural kinds of pigment each having different average particle diameters within the above-mentioned range may be used in combination. When the average particle diameter is 1 μm or greater, the rate of ink-absorption is enhanced. When the average particle diameter is 12 μm or less, the deterioration of the smoothness or glossiness of the ink-receptive layer can be prevented.

In order to adjust the ink absorption and prevent infiltration of the coating liquid for the ink-receptive layer applied on the undercoating layer, a pigment with a small average particle diameter, such as a pigment with an average particle diameter of less than 1 μm, may be formulated as the minor component Examples of such a pigment include colloidal silica and alumina sol, and colloidal silica is particularly preferable.

It is preferable that the colloidal silica (S) to be contained as the minor component be formulated in combination with a polymer resin (P) produced by polymerizing a monomer having an ethylenically unsaturated bond.

That is, it is preferable that the undercoating layer contain the colloidal silica (S) and the polymer resin (P) produced by polymerizing a monomer having an ethylenically unsaturated bond, or contain a complex thereof.

By such a constitution, the glossiness is improved. The reason for this is not clear, but it is assumed that the existence of the colloidal silica (S) and the polymer resin (P), or the existence of the complex thereof prevents a coating liquid for forming a coating layer from infiltrating into the undercoating layer, while maintaining the ink-absorbability of the undercoating layer. Also, the releasability from the heated specular surface at a time of subjecting cast-finishing to-the surface of the ink-receptive layer tends to be improved although the reason for this is uncertain.

The colloidal silica (S) is suitably selected from an alkaline type and acid type in accordance with physical properties, such as pH, of the coating liquid for forming the undercoating layer. As the colloidal silica (S), both a spherical one and nonspherical one may be used The nonspherical colloidal silica is a colloidal silica in which spherical colloidal silicas are connected in series or in a partially branched state. The sperical colloidal silica tends to be superior from the standpoint of ease to realize the glossiness, but the nonspherical colloidal silica tends to be superior from the standpoint of the ink-absorption. Accordingly, in view of these characteristics, either one of the two may be selected or both may be mixed to use.

Although the average particle diameter of the colloidal silica (S) is not particularly limited, it is preferable that the average particle diameter be 4 to 200 nm, and particularly 10 to 60 nm.

Although the content of the colloidal silica (S) is not particularly limited, it is preferable that the content be 1 to 30 parts by mass, and particularly 1 to 10 parts by mass, with respect to 100 parts by mass of other components of pigment.

The ethylenically monomer of the polymer resin (P) is not particularly limited, and examples thereof include acrylic acid esters such as methyl acrylate, ethyl acrylate, butyl acrylate, 2-ethylhexyl acrylate, lauryl acrylate, 2-hydroxyethyl acrylate, glycidyl acrylate, and the like, methacrylic acid esters such as methyl methacrylate, ethyl methacrylate, 2-hydroxyethyl methacrylate, 2-hydroxypropyl methacrylate, glycidyl methacrylate, and the like, styrene, α-methyl styrene, vinyl toluene, acrylonitrile, vinyl chloride, vinylidene chloride, vinyl acetate, vinyl propionate, acrylamide, N-methylol acrylamide, ethylene, butadiene, and the like.

The polymer resin (P) may be a single polymer or a copolymer, and also may be a substituted derivative of the polymer or copolymer. Examples of the substituted derivative include those in which a carboxy group is introduced or the introduced carboxy group is modified to be alkali-reactive.

Although the content of the polymer resin (P) is not particularly limited, it is preferable that the content be 1 to 20 parts by mass, and particularly 1 to 5 parts by mass, with respect to 100 parts by mass of other components of pigment excepting the colloidal silica (S).

The complex of the colloidal silica (S) and the polymer resin (P) can be produced, for example, in accordance with the following methods:
(1) the ethylenically monomer, which is a raw material of the polymer resin (P), is polymerized in the presence of a silane coupling agent and the like together with the colloidal silica (S) to produce a Si—O—P bond (P: polymer component), which results in generation of the polymer resin (P) complexed with the colloidal silica (S);
(2) the polymer resin (P) modified by a silanol group or the like, as needed, is reacted with the colloidal silica (S) to make the complex by producing a Si—O—P bond (P: polymer component); and the like.

The glass transition point (Tg) of the polymer component (polymer resin (P)) of the complex is preferably 40° C. or higher, and more preferably within a range from 50 to 100° C. When the glass transition point is 40° C. or higher, the film formation tends not to proceed excessively at a time of drying, the ink-absorption tends to be fast, and the ink-bleeding tends to scarcely occur. Also, when the glass transition point is 40° C. or higher, the releasability from a specular drum tends to be improved at a time of bringing the layer into contact and press to the mirror-finished metal surface, and preferably further drying, while a surface layer is in a wet state so as to impart the high glossiness to the recording sheet, although the reason for this is not necessarily clear.

The content of the complex is preferably 1 to 40 parts by mass, and even more preferably 1 to 15 parts by mass, with respect to 100 parts by mass of other components of pigment excepting the colloidal silica (S).

Also, the ratio (mass ratio) of the colloidal silica (S) to the polymer resin (P) in the complex is preferably within a range between 95 to 5 and 50 to 50, and more preferably 80 to 20 and 60 to 40.

As the adhesive to be contained in the undercoating layer, proteins such as casein, soy-bean protein, synthesized protein, or the like, various starches such as starch, oxidized starch, or the like, polyvinyl alcohols such as polyvinyl alcohol, cationic polyvinyl alcohol, silyl-modified polyvinyl alcohol, other modified polyvinyl alcohols, or the like, cellulose derivatives such as carboxymethyl cellulose, methyl cellulose, or the like, unconjugated diene-based polymer latexes such as styrene-butadiene copolymer or methyl methacrylate-butadiene copolymer, acryl-based polymer latexes, vinyl-based polymer latexes such as ethylene-vinyl acetate copolymer, or the like, aqueous polyurethane resins, aqueous polyester resins, or other conventionally known adhesives generally used for a coated sheet may be used alone or in combination.

The aqueous polyurethane resin is also commonly known as a urethane emulsion, urethane latex, polyurethane latex, or the like. The polyurethane resin is one produced from reaction of a polyisocyanate compound and a compound having an active hydrogen. It is a polymeric compound having a relatively large number of urethane bonds and urea bonds.

The content ratio of the adhesive to the pigment, although dependent on the kinds used thereof, is generally adjusted to be within a range between 1 and 100 parts by mass, and more preferably 2 and 50 par by mass, with respect to 100 parts by mass of the pigment.

In the undercoating layer, an ink fixing agent such as various cationic compounds may be formulated, as needed. However, substantial absence of such a component in the undercoating layer is preferable because the printing density tends to increase. However, minute amounts of a cationic surfactant or the like may be formulated as an auxiliary.

Moreover, various auxiliaries generally used for producing a coated sheet, such as a dispersing agent, thickener, antifoamer, antistatic agent, antiseptic agent or the like, may be suitably included in the undercoating layer. Also, a fluorescent dye, or coloring agent may be included in the undercoating layer.

Also, a temperature-sensitive polymeric compound described below may be included in the undercoating layer. When the temperature-sensitive polymeric compound is included, the quality of an image printed using an ink jet printer tends to be further bright. The reason for this is assumed that the production process in which the undercoating layer containing the temperature-sensitive polymeric compound is cooled at a temperate no higher tan the temperature-sensitive point of the temperature-sensitive polymeric compound to increase viscosity of the layer or gelate the layer, and then dried by drying with hot air or the like, suppresses occurrence of minute roughness generally caused by wind pressure at the time of drying.

However, it is preferable in view of cost that the temperature-sensitive polymeric compound be not formulated, because the formulation of the temperature-sensitive polymeric compound increases the cost of raw materials and requires cost for controlling the temperature of the coating liquid for the undercoating layer formed as needed, the temperature requiring to be controlled.

Accordingly, the formulation of die temperature-sensitive polymeric compound into the undercoating layer may be suitably determined in view of the relation between quality of objective products and cost.

The undercoating layer can be formed by applying the coating liquid for the undercoating layer composed by the above-mentioned materials onto an air-permeable support and then drying.

The solid content of the coating liquid for the undercoating layer is generally adjusted to approximately 5 to 50% by mass.

The coating amount of the coating liquid for the undercoating layer is preferably 2 to 60 g/m², more preferably approximately 2 to 30 g/m², and even more preferably approximately 4 to 10 g/m², in dry mass. When the coating amount is 2 g/m² or greater, the ink absorbability is sufficiently improved, and an excellent glossiness is realized at a time of forming the ink-receptive layer. When the coating amount is 60 g/m² or less, there is a tendency in which the printing density is increased, the strength of the coating layer is enhanced, or powdering or scratching scarcely occurs.

In order to apply the coating liquid for forming the undercoating layer as needed, various known coating devices such as blade coater, air-knife coater, roll coater, brush coater, champflex coater, bar coater, lip coater, die coater, gravure coater, curtain coater, slot die coater, slide coater, or the like, may be used.

Moreover, after forming the undercoating layer, a smoothing treatment such as super calender, brushing, or the like may he conducted, as needed. The undercoating layer may be formed as at least two layers.

“Ink-Receptive Layer”

The ink-receptive layer is formed by applying a coating liquid containing at least both a temperature-sensitive polymeric compound and a pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity, onto either an air-permeable support or at least one undercoating layer provided on the air-permeable support in the temperature region where the temperature-sensitive polymeric compound exhibits hydrophobicity, to form a coating layer of the coating liquid; bringing a temperature of the coating layer to the temperature region where the temperature-sensitive polymeric compound exhibits hydrophilicity to increase the viscosity of the coating layer or gelate the coating layer; then applying a wetting liquid containing an ink fixing agent (such as, for example, a cationic compound) onto the viscosity-increased or gelated coating layer; followed by bringing the assembly into contact and press to a heated specular surface and drying. In particular, it is preferable that at least 75% by mass of the whole ink fixing agent contained in the ink-receptive layer of the ink jet recording sheet be provided by the wetting liquid.

The coating surface with extremely high smoothness and high reflectance can be realized by applying a coating liquid containing at least both the temperature-sensitive polymeric compound and the pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity; bringing a temperature of the coating layer to the temperature region where the temperature-sensitive polymeric compound exhibits hydrophilicity to increase the viscosity of the coating layer or gelate the coating layer; then applying the wetting liquid onto the coating layer; followed by bringing the assembly into contact and press to the heated mirror-finished metal surface and drying.

The reason for this is assumed that viscosity-increasing or gelating of the coating liquid prevents the coating layer from cracking, and omits processes of applying a cross-linking agent or the like for viscosity-increasing or gelating because the coating liquid can acquire a high-viscosity or gelate when the temperature thereof is changed, as a result of which uneven swelling of the coating layer is prevented, so the deterioration of the smoothness is prevented. Also, the reason is assumed that only the outermost surface of the coating layer is plasticized by applying the wetting liquid onto the viscosity-increased or gelated coating layer, and extremely high smoothness, which results in a highly reflective coating surface, can be realized by bringing the assembly into contact and press to the heated mirror-finished metal surface.

It is assumed that combination of these effects of providing highly reflective coating surface and retaining most of ink dye near the surface of the coating layer realizes high printing density, as a result of which colors of a printed image become bright.

Moreover, the existence of the ink fixing agent in the wetting liquid enables an ink jet recording sheet to realize the high printing density at a time of printing using a dye-type ink jet ink, as-a result of which an image with bright colors can be printed. The reason for this is not clear, but it is assumed that when the ink fixing agent is contained in the wetting liquid, and preferably 75% by mass or greater of the ink fixing agent is contained in the wetting liquid, large amounts of the ink fixing agent exist near the surface of the ink-receive side of the ink jet recording sheet, the ink fixing agent exists inside the layer in such a distribution manner that the content thereof decreases in the thickness direction from the surface of the layer, and most of the provided ink dye is retained near the surface of the ink-receptive layer. Also, when the ink fixing agent is contained in the wetting liquid, the glossiness is further improved, although the reason for this is not clear.

It is preferable that the content of the ink fixing agent contained in the wetting liquid be 75% by mass or greater of the whole cationic compounds contained in the recording sheet. When the content of the ink fixing agent contained in the wetting liquid is extremely small, the printing density tends to decrease, probably because it becomes difficult to retain most of the ink dye provided at a time of printing using a dye-type ink jet ink near the surface of the layer.

In the following, components of the ink-receptive layer will be explained.

“Temperature-Sensitive Polymeric Compound”.

Examples of the temperature-sensitive polymeric compound include: (1) ones that exhibit hydrophilicity in a temperature region lower than the temperature-sensitive point (the temperature at which change between hydrophilicity and hydrophobicity occurs), but exhibit hydrophobicity in a temperature region higher tan the temperature-sensitive point; and (2) ones that exhibit hydrophobicity in a temperature region lower than the temperature-sensitive point, but exhibit hydrophilicity in a temperature region higher than the temperature-sensitive point. The coating liquid containing the temperature-sensitive polymeric compound and a pigment does not acquire a high-viscosity or gelate in the temperature region where the temperature-sensitive polymeric compound exhibits hydrophobicity, but acquires a high-viscosity or gelates in the temperature region where the temperature-sensitive polymeric compound exhibits hydrophilicity. When such a coating liquid is used, viscosity-increasing or gelating is uniformly conducted by aging the temperature without using a gelating agent or cross-linking agent, as a result of which the glossiness and smoothness of the formed ink-receptive layer are improved, and the density realized at a time of printing using a dye-type ink jet ink is enhanced.

In the case of type (1), the coating layer can acquire a high-viscosity or gelate when the coating liquid of which the temperature is adjusted to a temperature higher than the temperature-sensitive point is applied, followed by lowering the temperate thereof to a temperature lower than the temperature-sensitive point. In the case of type (2), the coating layer can acquire a high-viscosity or gelate when the coating liquid of which the temperature is adjusted to a temperature lower than the temperature-sensitive point is applied, followed by raising the temperature thereof to a temperature higher than the temperature-sensitive point. However, in the case of type (2), it is relatively difficult to control the moisture content of the coating layer at a time of applying the wetting liquid, because the moisture is evaporated at a time of raising the temperature for increasing the viscosity of the coating layer or gelating the coating layer. Accordingly, type (1) that can cause the coating layer to acquire a high-viscosity or gelate by lowering the temperature thereof is particularly preferable in the present invention. La the following, this type will be explained.

The change between hydrophilicity and hydrophobicity of the temperature-sensitive polymeric compound appears as a drastic change of viscosity, transparency, aqueous solubility of the temperature-sensitive polymeric compound, or the like, accompanying the temperature change, in a system where the temperature-sensitive polymeric compound and water exist together.

Accordingly, in the case of the type which exhibits hydrophilicity in a temperature region lower than the temperature-sensitive point but exhibits hydrophobicity in a temperature region higher than the temperature-sensitive point, the transition point at which the viscosity is drastically changed (increased) may be determined as the temperature-sensitive point in a temperature-viscosity curve obtained by gradually decreasing the temperate of the system where the temperature-sensitive polymeric compound and water exist together from the temperature region (higher than the temperature-sensitive point) where the temperature-sensitive polymeric compound exhibits hydrophobicity. As another way, the temperature-sensitive point may be determined by gradually decreasing the temperature of an aqueous dispersion of the temperature-sensitive polymeric compound prepared in the temperature region (higher than the temperature-sensitive point) where the temperature-sensitive polymeric compound exhibits hydrophobicity and measuring the temperature at which the aqueous dispersion begins to become transparent or be gelated.

The conversion from hydrophobicity to hydrophilicity of the temperature-sensitive polymeric compound between over and below the temperature-sensitive point may be a reversible or irreversible conversion. However, when a pigment such as silica exists in the system containing the temperature-sensitive polymeric compound and water, the conversion irreversibly proceeds. Accordingly, once the temperature-sensitive polymeric compound exhibits hydrophilicity and acquires a high-viscosity or gelates by cooling the coating layer formed by applying the coating liquid in the temperature region higher than the the temperature-sensitive point, where the temperature-sensitive polymeric compound exhibits hydrophobicity, the temperature-sensitive polymeric compound does not exhibit hydrophobicity even if the layer is heated again, and thus a conventional drying method may be adopted.

Although the temperature-sensitive point of the temperature-sensitive polymeric compound is not particularly limited, it is preferable that it be within a range from 0 to 30° C., and particularly from 10 to 25° C. When the temperature-sensitive point is 0° C. or higher, the temperature of the coating layer can be brought below the temperature-sensitive point with relative ease, and thereby the efficiency for increasing the viscosity or gelating becomes favorable. When it takes a long time to bring the temperature below the temperature-sensitive point there is a possibility that the coating liquid infiltrates the undercoating layer or air-permeable support in the meantime, as a result of which the favorable ink-receptive layer is not formed, and the glossiness is deteriorated In contrast, when the temperature-sensitive point is over 30° C., it becomes difficult to control the temperature at a dime of coating, and the coating liquid acquires a high-viscosity or gelates as soon as coating, and thus uniform coating or control of increasing the viscosity or gelating is difficult.

Examples of a favorably used temperature-sensitive polymeric compound include temperature-sensitive polymeric compounds produced by conducting polymerization in the presence of polyvinyl alcohol and/or derivatives thereof, as disclosed in Patent document 4.

Specific examples thereof include polymeric compounds produced by polymerizing, in the presence of polyvinyl alcohol and/or derivatives thereof, a monomer (main monomer (M)) that can produce a polymeric compound exhibiting temperature-response (change between hydrophilicity and hydrophobicity) by homopolymerization, and, as needed, a monomer (submonomer N)) that can be copolymerized with the main monomer, but cannot produce the polymeric compound exhibiting the temperature response by homopolymerization.

The polyvinyl alcohol and/or the derivatives thereof, the main monomer (M), and the submonomer (N) may be each used alone or in combination of at least two kinds thereof.

Examples of the polyvinyl alcohol include polyvinyl alcohols having a saponification degree of 96 to 100% (completely saponified grade polyvinyl alcohols), polyvinyl alcohols (partially saponified grade polyvinyl alcohols) having a saponification degree of 76 to 95%, and the like. Examples of the derivatives of polyvinyl alcohol include modified polyvinyl alcohols such as silanol-modified ones, cationically-modified ones, and the like, and polyvinyl alcohols having an introduced mercapto group, keto group, or the like. Although the polymerization degree of these is not particularly limited, it is preferable that the polymerization degree be 300 to 4000.

Although the content ratio of the polyvinyl alcohol and/or the derivative thereof in the temperature-sensitive polymeric compound is not particularly limited, it is preferable in view of water-resistance of the ink-receptive layer that the content ratio be 0.1 to 50% by mass, and particularly 0.5 to 20% by mass.

Examples of the main monomer (M) include N-alkyl- or N-alkylene-substituted (meth)acrylamide derivatives, vinylmethylethers, and the like.

Specific examples thereof include N-ethyl(meth)acrylamide, N-isopropyl(moth)acrylamide, N-cyclopropyl(meth)acrylamide, N-ethyl(meth)acrylamide, N,N-diethyl acrylamide, N,N-dimethyl(meth)acrylamide, N-n-propyl(meth)acrylamide, N-methyl-N-n-propyl acrylamide, N-methyl-N-isopropyl acrylamide, N-(meth)acryloyl pyrrolidine, N-(meth)acryloyl piperidine, N-tetrahydrofurfuryl(meth)acrylamide, N-methoxypropyl(meth)acrylamide, N-ethoxypropyl(meth)acrylamide, N-isopropoxypropyl(meth)acrylamide, N-ethoxyethyl(meth)acrylamide, N-(2,2-dimethoxyethyl)-N-methyl acrylamide, N-methoxyethyl(meth)acrylamide, N-(met)acryloyl morpholine, and the like.

Examples of the submonomer (N) include oleophilic vinyl compounds, hydrophilic vinyl compounds, ionic vinyl compounds, and the like.

Specific examples of the oleophilic vinyl compounds include methyl(meth)acrylate, ethyl(meth)acrylate, n-butyl(meth)acrylate, 2-ethylhexyl(meth)acrylate, glycidyl methacrylate, styrene, α-methylstyrene, ethylene, isoprene, butadiene, vinyl acetate, vinyl chloride, and the like.

Specific examples of the hydrophilic vinyl compounds include 2-hydroxyethyl(meth)acrylate, 2-hydroxypropyl(meth)acrylate, (meth)acrylamide, N-methylol acrylamide, diacetone acrylamide, methylenebis acrylamide, 2-methyl-5-vinylpyridine, N-vinyl-2-pyrrolidone, N-acryloyl pyrrolidine, and the like.

Specific examples of the ionic vinyl compounds include carboxylic group-containing monomers such as acrylic acid, methacrylic acid, itaconic acid, fumaric acid, maleic acid, crotonic acid, butenetricarboxylic acid, monoethyl maleate, monomethyl maleate, monoethyl itaconate, monomethyl itaconate, and the like, sulfonic group-containing monomers such as 2-acrylamide-2-methyl-propanesulfonic acid, styrenesulfonic acid, vinylsulfonic acid, (meth)acrylsulfonic acid, and the like, amino group-containing monomers such as N,N-dimethylaminoethyl(meth)acrylate, N,N-diethylaminoethyl(meth)acrylate, and the like.

Although the copolymerization ratio of the main monomer (M) and the submonomer (N) used as needed is not particularly limited, it is preferable that the ratio of the submonomer (N) in the temperature-sensitive polymeric compound be 50% by mass or less, and particularly 30% by mass or less, because the obtained compound does not exhibit the temperature-response when the ratio of the submonomer (N) is extremely high.

It is preferable that the temperate-sensitive polymeric compound be contained in the coating liquid for the ink-receptive layer in a form of a polymeric emulsion. Such a polymeric emulsion is commercially available under the trade name of ALB-221, ALB-244, or the like, manufactured by Asahi Kasei Corporation., for example. Also, the polymeric emulsion may be prepared to use. The polymeric emulsion can be prepared in accordance with a procedure disclosed in Patent document 4. That is, the polymeric emulsion can be prepared by polymerizing the above-mentioned monomers in the presence of the polyvinyl alcohol and/or the derivative thereof at a temperature lower than the temperature-sensitive point of the temperature-sensitive polymeric compound. In more detail, an emulsifying agent is dissolved in water, to which the polyvinyl alcohol and/or the derivative thereof, the main monomer (M), the submonomer (N) as needed, and a radical polymerization initiator are added for conducting emulsion polymerization. The monomers and radical polymerization initiator may be added collectively, successively, or divisionally.

Although the glass transition point of the temperature-sensitive polymeric compound is not particularly limited in the case where high gloss finish is provided on an ink jet recording sheet using a heated specular roll while the surface layer of the sheet is in a wet state, it is preferable that the glass transition point be 50 to 150° C. from the standpoint of workability of bringing the layer into contact and press to the surface of the roll, preferably for drying, and generally preferable that the glass transition point be 80 to 120° C. from the standpoint of impartation of flexibility to the obtained recording sheet. When the glass transition point is below 50° C., the film formation of the coating layer proceeds extremely at a time of drying, the proportion of pores in the surface decreases, and so ink-bleeding or solid-irregularities tend to easily occur at a time of conducting ink jet recording. On the other hand, when the glass transition point exceeds 150° C., the film formation property tends to be insufficient, and the glossiness tends to decrease.

The coating liquid for forming the ink-receptive layer can be prepared by mixing the above-mentioned polymeric emulsion, pigment, and other components.

Although water is preferably used as a solvent of the coating liquid, an organic solvent or a mixture of water and an organic solvent may be used instead of water, for the purpose of adjusting the temperature-sensitive point of the temperature-sensitive polymeric compound, delaying the drying rate at a time of cast-finishing to form an ink-receptive layer with favorable printability, or the like.

After the coating liquid for forming the ink-receptive layer is prepared, the coating liquid is preferably held at a temperature higher than the temperature-sensitive point until the coating liquid is used for coating.

“Pigment”.

Although the pigment composing the ink-receptive layer is not particularly limited, examples thereof include kaolin, clay, baked clay, nonerystalline silica (amorphous silica), synthesized noncrystalline silica, zinc oxide, aluminum oxide, titanium oxide, aluminum hydroxide, calcium carbonate, Satin White, aluminum silicate, alumina, colloidal silica, zeolite, synthesized zeolite, sepiolite, smectite, synthesized smectite, magnesium silicate, magnesium carbonate, magnesium oxide, diatomaceous earth, styrene-based plastic pigment, hydrotalcite, urea resin-based plastic pigment, benzoguanamine-based plastic pigment, and the like. These may be used alone, or in combination of at least two kinds thereof.

Although the pigment is not particularly limited in terms of the average particle diameter, a line pigment with an average particle diameter of 10 to 1000 nm is preferably used. The use of such a pigment with the average particle diameter can suppress deterioration of transparency of the ink-receptive layer and deterioration of coloring properties (that is, decrease of printing density) caused thereby at a time of printing, while realizing favorable ink absorbability.

It is preferable that the average particle diameter of primary particle composing the above-mentioned fine pigment be 3 nm or greater but 40 nm or smaller, more preferably 5 nm or greater but 30 nm or smaller, and even more preferably 7 nm or greater but 20 nm or smaller. When the average primary particle diameter is smaller than 3 nm, there is a tendency in which the proportion of air gaps among primary particles is significantly small, as a result of which the ability of absorbing solvents or coloring agents contained in ink is deteriorated, and thereby a desired image quality cannot be realized. In contrast, when the average primary particle diameter is greater than 40 nm, there is a tendency in which agglomerated secondary particles are enlarged, as a result of which the transparency of the ink-receptive layer is deteriorated, and coloring properties of the coloring agent fixed in the ink-receptive layer at a time of ink-jet-recording are deteriorated, and thereby a desired printing density cannot be realized.

The fine pigment with an average particle diameter of 1,000 nm or smaller can be prepared by applying a strong force using a mechanical apparatus in accordance with a so-called breaking down method (in which aggregated raw materials are broken into parts), for example. Examples of the mechanical apparatus include an ultrasonic homogenizer, pressure-type homogenizer, liquid-liquid collision type homogenizer, rapidly-rotating mill, roller mill, container driven medium mill, medium sting mill, jet mill, mortar, disintegrator (apparatus for grinding and kneading an object in a bowl-shaped container using a pestle-shaped stirring bar), sand grinder, and the like. In order to decrease the particle diameter, classification and repeated pulverization can be conducted.

As the fine pigment, at least one selected from the group consisting of a fumed silica, mesoporous silica, colloidal matter of wet silica prepared by condensing active silica, alumina oxide, and alumina hydrate, and particularly a fumed silica and/or alumina oxide, is preferably used.

In the present invention, the “average particle diameter” of the pigment is determined, regardless of the form (such as powder or slurry) of the pigment, by preparing 200 g of an aqueous dispersion containing 3% of the pigment, stirring and dispersing the dispersion using a commercially available homomixer (under a dispersion condition of 1000 rpm for 30 minutes), immediately observing the dispersion using an electron microscope (SEM and/or TEM), taking an electron micrograph at 10,000 to 400,000-fold magnification, measuring the Martin's diameter of particles within a 5-cm square, and averaging obtained values (see “Fine particle handbook”, Asakura Shoten, page 52, 1991).

“Adhesive”

Although the above-mentioned temperature-sensitive polymeric compound exhibits adhesive action, well-known adhesives may be suitably formulated in the ink-receptive layer so as to adjust the layer-strength or the ink-absorbability. Examples thereof include proteins such as casein, soy-bean protein, synthesized protein, and the like, various stares such as starch, oxidized starch, and the like, polyvinyl alcohols such as polyvinyl alcohol, modified polyvinyl alcohols such as cationic polyvinyl alcohol, silyl-modified polyvinyl alcohol, and the like, cellulose derivatives such as carboxymethyl cellulose, methyl cellulose, and the like, unconjugated diene-based polymer latexes such as styrene-butadiene copolymer, methyl methacrylate-butadiene copolymer, and the like, acryl-based polymer latexes, vinyl-based polymer latexes such as ethylene-vinyl acetate copolymer, and the like, aqueous polyurethane resins, aqueous polyester resins, and the like. These may be used alone or in combination of at least two kinds thereof The aqueous polyurethane resins are preferably used in the form of polyurethane emulsion, polyurethane latex, or the like. These may be used together with the temperature-sensitive polymeric compound, unless the effects of the temperature-sensitive polymeric compound are impaired.

Although the content ratio of the pigment and the adhesive (containing the temperature-sensitive polymeric compound) is not particularly limited, and is determined in view of the kinds of these combined matters, it is preferable that 1 to 100 parts by mass, particularly 2 to 50 parts by mass of the adhesive be formulated with respect to 100 parts by mass of the pigment.

“Coating Liquid for Ink-Receptive Layer”.

The coating liquid for the ink-receptive layer contains the above-mentioned temperature-sensitive polymeric compound and the pigment, and further contains an adhesive, as needed. The coating liquid is applied in the temperature region where the temperature-sensitive polymeric compound exhibits hydrophobicity. In the coating liquid, an ink fining agent may be formulated. The ink fixing agent is a component that fixes components of the coloring agent (dye and/or coloring pigment) conned in ink, and is used, as needed, so as to improve coloring properties or storage durability of printing.

Examples of the ink fixing agent include various well-known cationic compounds and the like. Specific examples thereof include: (1) polyalkylene polyamines such as polyethylene polyamine or polypropylene polyamine, and derivatives thereof; (2) acrylic polymers having a secondary amino group, tertiary amino group, or quaternary ammonium group, and acrylamide copolymers thereof; (3) polyvinylamines and polyvinylamidines; (4) dicyan-based cationic compounds exemplified by dicyandiamide-formalin copolymers; (5) polyamine-based cationic compounds exemplified by dicyandiamide-polyethyleneamine copolymers; (6) epichlorohydrin-dimethylamine copolymers; (7) diallyldimethyl ammonium-SO₂ polycondensation products; (8) diallylamine salt - S0₂ polycondensation products; (9) diallyldimethyl ammonium chloride polymers; (10) diallyldimethyl ammonium chloride-acrylamide copolymers; (11) copolymers of allylamine salts; (12) dialkylaminoethyl (meth)acrylate quaternary salt copolymers; (13) acrylamide-diallylamine copolymers; (14) cationic resins having a five-membered cyclic amidine suture, and the like; (15) dimethylaminopropylacrylamide polymers, and the like. These may be used alone or in combination of at least two kinds thereof.

Among these, it is preferable hat at least one selected from the group consisting of diallyl dimethyl ammonium chloride polymers, diallyl dimethyl ammonium chloride-acrylamide copolymers, hydrochloride salts of acrylamide-diallylamine copolymers, dicyandiamide-polyethyleneamine copolymers, and cationic resins having a five-membered cyclic amidine suture be used, because printing with excellent coloring properties and less bleeding, and free from coloring irregularities can be realized.

It is preferable in the present aspect that the ink fixing agent to be formulated in advance in the coating liquid for the ink-receptive layer be less than 25% by mass, because the ink fixing agent is formulated in the wetting liquid described below. The ink fixing agent to be formulated in advance may be different from the ink fixing agent to be formulated in the wetting liquid.

Since the silica preferably used as the pigment generally exhibits anionic properties, there is a case in which the silica forms agglomeration with the cationic ink fixing agent. In particular, fine silica significantly causes this phenomenon. In this case, it is preferable to adopt a procedure in which at least a part of the ink fixing agent is added to and dispersed in a generally commercially available noncrystalline silica (having a relatively large secondary particle diameter of several micrometers), arid pulverized to fine parts, or a procedure in which an ink fixing agent is added to and mixed with a secondary particle dispersion of a finely pulverized sicila to form agglomeration, and then the agglomeration is pulverized again. Thus, it is possible to suppress formation of an agglomeration with large particle diameter and to adjust the particle diameter of the pigment to a desired diameter.

The pigment treated in such a way has a characteristic in that aggregates hardly occur even when the ink fixing agent is further added, probably because the pigment is stabilized by forming a structure in which the ink fixing agent is partially bonded. In the following, such a pigment is referred to as cationic fine pigment. As the pigment used for the cationic fine pigment, silica, particularly firmed silica, is preferably used, although aluminosilicate may be used other than silica.

For the purpose of dispersing or pulverizing the mixture of the pigment and the ink fixing agent or the agglomerated matter thereof, a homomixer, a pressure-type homogenizer, an ultrasonic homogenizer, a microfluidizer, an ultimaizer, a nanomizer, a rapidly rotating mill, a roller mill, a container driven medium mill, a medium stirring mill, a jet mill, a sand grinder, a Crea Mix, or the like, may be used.

When the average secondary particle diameter of the cationic fine pigment exceeds 1000 nm, the mixture or agglomerated matter can be sufficiently dispersed by applying a weak mechanical force using a homomixer, or the like. However, application of a stronger mechanical force is effective for the purpose of pulverizing the mixture or agglomerated matter to particles with an average secondary particle diameter of 1000 nm or smaller, and thus a pressure-type dispersion method is preferably used.

In the present invention, the pressure-type dispersion method is a method in which a slurry mixture of raw particulate materials is pulverized at a high pressure by continuously passing the mixture trough an orifice at a high pressure, the treatment pressure being 19.6×10⁶ to 343.2×10⁶ Pa (200 to 3500 kgf/cm²), more preferably 49.0×10⁶ to 245.3×10⁶ Pa (500 to 2500 kgf/cm²), and even more preferably 98.1×10⁶ to 196.2×10⁶ Pa (1000 to 2000 kgf/cm²). The above-mentioned high-pressure pulverization realizes favorable dispersion or pulverization. Moreover, it is more preferable that dispersion or pulverization be conducted by letting the slurry mixture through the orifice at a high pressure to collide head-on with each other. In order to make the slurry mixture collide head-on, the dispersion is pressured to direct it to an inlet side and divide it to flow into two passages, the flow rates thereof are enhanced by narrowing the flow passages using the orifice, and thus the dispersion is made to collide head-on so that particles are made to collide to pulverize them. As a material used for forming a portion in which the dispersion is accelerated or made to collide, diamond is preferably used due to its abrasion resistance or the like.

As a high pressure pulverizer, a pressure-type homogenizer, an ultrasonic homogenizer, a microfluidizer, or a nanomizer may be used, and the microfluidizer and the nanomizer are particularly preferable as a high speed colliding type homogenizer.

The cationic fine pigments treated in such a way are generally obtained as an aqueous dispersion (a slurry or colloidal particles) with a solid concentration of approximately 5 to 20% by mass.

Although the mass ratio of the pigment and the ink fixing agent in the cationic fine pigment is not particularly limited, it is preferable that 1 to 30 parts by mass, particularly 3 to 20 parts by mass of the ink firing agent be formulated with respect to 100 parts by mass of the pigment. Moreover, it is preferable that the ratio of the cationic fine pigment in the whole pigment composing the ink-receptive layer be 50% by mass or greater, because the transparency of the ink-receptive layer is excellent.

Various additives generally for manufacturing a coated sheet, such as a dispersing agent, thickener, antifoamer, antistatic agent, antiseptic agent, fluorescent whitening agent, coloring agent or the like may be added to the coating liquid for the ink-receptive layer. Also, a preservability-improver as described in tie below section of the wetting liquid may be added to the coating liquid for the ink-receptive layer, and is preferable.

The solid content of the coating liquid for the ink-receptive layer is generally adjusted to approximately 5 to 50% by mass, and preferably 5 to 20% by mass. When the solid content is 5% by mass or greater, the drying efficiency of the ink-receptive layer is improved. In contrast, when the solid content is 20% by mass or less, the moisture content of the coating layer before treating with the wetting liquid for forming the surface layer is easily made to be 12% by mass or greater, which is a favorable amount as described below.

In order to apply the above-mentioned coating liquid on the air-permeable support or the undercoating layer formed, as needed, various coating device such as a blade coater, air-knife coater, roll coater, brush coater, champflex coater, bar coater, lip coater, gravure coater, curtain coater, slot die coater, slide coater, spray, or the like, may be used. Among these, an air-knife coater, lip coater, slide coater, curtain coater, or slot die coater is preferably used. When these coating devices are used, the glossy texture tends to become further favorable, probably because the coating layer with uniform thickness is formed without being influenced by fie unevenness of the air-permeable support or undercoating layer.

Although the coating amount is not particularly limited, it is preferable that the coating amount be 2 to 15 g/m², more preferably 2 to 10 g/m², and particularly 3 to 8 g/m², in dry mass. When the coating amount is 2 g/m² or greater, the excellent glossiness and ink absorbability can be realized. When the coating amount is 15 g/m² or less, the ink-receptive layer is prevented from cracking, and the dot roundness or the like at a time of ink-jet printing becomes favorable.

After the coating layer is formed, the coating layer is further cooled to a temperature lower tan the temperature-sensitive point in a wet state or slightly dried state. Although methods for cooling are not particularly limited, a cold air fan, cooling roll, low-temperature gas, or the like may be used to cool. By cooling, the coating layer of the coating liquid is caused to become more viscous or gelate.

Since there is a case in which excessive cooling extremely enhances the degree of gelation, as a result of which the glossiness is impaired, it is preferable that the coating layer be cooled to a temperature within a range from a temperature lower than the temperature-sensitive point by 10° C. to a temperature lower than the temperature-sensitive point.

Moreover, it is preferable that the ground surface (surface of the air-permeable support or undercoating layer) to be coated with the coating layer of the coating liquid be cooled in advance to a temperature lower than the temperature-sensitive point, particularly a temperature lower than the temperature-sensitive point by 10° C. or greater, by applying cold air, applying a treatment liquid with a temperature lower than the temperature-sensitive point, or the like. This process can enhance the cooling efficiency after applying the liquid. In particular, it is preferable that the treatment liquid with a temperature lower than the temperature-sensitive point be directly applied onto the ground surface, because the ground surface is rapidly cooled. Also, it is preferable from the standpoint of the efficiency of cooling the coating layer that the coating liquid for the ink-receptive layer be applied before the treatment liquid is dried.

Such a procedure can rapidly cause the coating layer to become more viscous or gelate the coating layer after applying the coating liquid, as a result of which an ink-receptive layer which is excellent in printability for ink jet recording or the like and also allows pigment ink to realize favorable printing, is formed.

In particular, a procedure in which the treatment liquid with a tempt lower than the temperature-sensitive point (for example, chilled water or the like) is applied on a sheet to be coated with the coating liquid can rapidly change the temperature of the sheet, and thus die procedure is even more preferable. It is preferable that the temperature of the treatment liquid at a time of being applied be lower Man the temperature-sensitive point by 10° C. or greater, because the temperature of the coating liquid for the ink-receptive layer is rapidly changed. In this case, the obtained ink jet recording sheet can realize uniform recording and also exhibits excellent recording suitability when using the pigment ink.

As the treatment liquid, water, an organic solvent or the like, can be used, and water is preferably used in view of ease of use It is preferable that a cationic compound or preservability-improver be added to the treatment liquid, because such components are infiltrated into the air-permeable support or undercoating layer, as a result of which water-resistance and resistance to heat, humidity, and bleeding are improved. In addition to these, a cross-linking agent such as a boron compound, zirconium compound, or the like, an auxiliary such as a pH adjuster, surfactant, antifoamer, antiseptic agent, or the like, may also be added. In order to form an ink-receptive layer with favorable printability by adjusting the temperature-sensitive point of the temperature-sensitive polymeric compound or delaying the drying rate at a time of cast-processing, an organic solvent may be formulated or used together.

When the above-mentioned type (2) of the temperature-sensitive polymeric compound is used, the coating liquid of which the temperature is adjusted to a temperature lower than the temperature-sensitive point is applied and is then heated to a temperature higher than the temperature-sensitive point so as to increase the viscosity of the coating liquid or gelate the coating liquid. Examples of such a compound include compounds disclosed in Japanese Unexamined Patent Application, First Publication No. H 8-244334. For example, the coating layer is caused to acquire a high-viscosity or gelate by heating the coating surface using a hot air device, infrared heater, or the like, so as to raise the temperature thereof.

The viscosity-increased or gelated coating layer is then dried, coated with the wetting liquid, brought into contact and press to a heated specular surface, and dried. Although the moisture content of the coating layer at a time of being coated with the wetting liquid is not particularly limited, it is preferable that drying be conducted so that the moisture content is 12% by mass or greater, and more preferably 12% by mass or greater but 40% by mass or less. when the moisture content of the coating layer at a time of being coated with the wetng liquid is less than 12% by mass, it tends to be difficult to stably form a high-gloss ink-receptive layer. The reason for this is assumed that the framework formation of the coating layer proceeds extremely by drying, and thereby the degree of plasticization caused by the wetting liquid becomes insufficient. When the moisture content of the coating layer at a time of being coated with the wetting liquid is extremely great, there is a tendency in which the amount of moisture-evaporation at a time of bringing the assembly into contact and press to a heated specular surface becomes grate, as a result of which defects such as pinholes or the like occur on the surface of the coating layer, and thereby the glossiness is deteriorated. It is preferable that the moisture content of the coating layer at a time of being coated with the wetting liquid be 14 to 35% by nmss, and more preferably 18 to 32% by mass. In order to dry the coating layer so that the moisture content thereof falls within the above-mentioned range, various well-known driers such as a hot air drier, infrared heater, or the like, may be preferably used.

In the present specification, the “moisture content of the coating layer” is measured using an infrared moisture gauge KJT-100 (manufactured by KETT ELECTRIC LABORATORY). The measurement is conducted at a location where no other members contact with the surface opposite to the measuring surface, because there is a case in which a measurement error occurs under the influence of another member such as a paper roll contacting with he surface opposite to the measuring surface.

When the infrared moisture gauge is used, light with an absorption wavelength of water, the absorption wavelength being within a near-infrared band (specifically, 1.2 μm, 1.45 μm, and 1.94 μm), is radiated to the coating layer, and the radiated light is absorbed in accordance with the moisture content of the layer. Accordingly, the attenuation of the radiated light is measured to determine the moisture content. To put it more precisely, the moisture content is calculated from the ratio of energies of light reflected when light with the absorption wavelength and light with near-infrared wavelength (reference wavelength) poorly influenced by water are alternatively radiated, because measurement merely using light with the absorption wavelength is influenced by the surface condition or color of the layer, or the like, and thereby is difficult to be stably conducted.

The moisture gauge is disposed in a position immediately anterior to a position where the treatment liquid is applied using a cast-coater. It is preferable that paper be held in the air, because there is a case in which a measurement error occurs under the influence of a paper roll existing on the opposite side (rear side) of the coated sheet to the measured surface.

It is preferable that the temperature of the mirror-finished metal surface be within ±20 ° C. of the glass transition temperature of the temperature-sensitive polymeric compound. When the glass transition temperature of the temperature-sensitive polymeric compound is lower than the temperature of the metal surface by greater than 20° C., there is a case in which the film formation of the ink-receptive layer proceeds extremely at a time of drying, as a result of which the proportion of surface pores decreases, and thereby the ink-bleeding occurs at a time of recording, and uneven print density is caused at a time of solid-printing. When the glass transition temperature is higher than the temperature of the metal surface by greater than 20° C., there is a case in which the film formation is insufficient, and the glossiness is deteriorated.

Moreover, it is preferable that the temperature of the metal surface be within a range from 80 to 120° C. When the temperature of the metal surface is lower than 80° C., there is a possibility in which the drying efficiency is not favorable and the productivity is deteriorated. When the temperature of the metal surface is higher than 120° C., there is a possibility in which bubbling of the coating liquid occurs due to sudden boiling on the metal surface, and thereby the glossiness or printability is deteriorated.

In the case where the coating layer is dried using a mirror-finished metal surface of a casting drum, when there is a possibility in which the coating layer is not sufficiently dried, predrying for drying the coating layer in advance may be conducted before bringing it into contact and press to the casting drum. Also, at the same time as drying using the casting drum, auxiliary drying using an auxiliary drying device may be conducted. Alternatively, drying may be further conducted in post process.

“Wetting Liquid”.

After the coating liquid for the ink-receptive layer is applied, the wetting liquid is applied on the coating surface of the ink-receptive layer, and then brought into contact and press to a heated mirror-finished metal surface in a viscosity-increased or gelated state. The wetting liquid wets the coating surface of the ink-receptive layer, and contains an ink fixing agent as an essential component thereof. It is preferable that at least 75% by mass of te whole ink fixing agent contained in the ink-receptive layer of the ink jet recording sheet be imparted by this wetting liquid. In the wetting liquid, a release agent or preservability-improver may be formulated.

The content of the ink fixing agent is preferably adjusted to 1 to 50% by mass, more preferably 2 to 20% by mass, and even more preferably 2 to 10% by mass. When the content is 1% by mass or greater, at least 75% by mass of the whole ink fixing agent contained in the ink-receptive layer of the ink jet recording sheet is easily applied. When the content is 50% by mass or less, it is possible to inhibit the following tendencies: the coating amount becomes excessively great, as a result of which air-gaps in the ink-receptive layer are covered, and thereby the ink-absorption is deteriorated.

As the ink fixing agent, various compounds well-known to be formulated in an ink jet recording sheet for Me purpose of fixing components of a coloring agent (dye or coloring pigment) contained in ink jet recording ink may be used, and a cationic polymeric compound having a primary to tertiary amino group or a quaternary ammonium base as a cationic group is preferably used, for example.

As the polymeric compound, homopolymers of a monomer having a primary to tertiary amino group or a quaternary ammonium base, copolymers of a monomer having such a cationic group and a monomer free from such a cationic group, hydrochloride salts, sulfate salts, nitrate salts, acetate salts, and organic acid salts, each having a substituted counter ion of the above-mentioned basic group, can be exemplified. Examples thereof include: 1) polyalkylene polyamines such as polyethylene polyamine and polypropylene polyamine, and derivatives thereof; 2) acryl polymers having a secondary amino group, tertiary amino group, or quaternary ammonium group; 3) polyvinylamines and polyvinylamidines; 4) dicyan-based cationic compounds such as a dicyandiamide-formalin copolymer; 5) polyamine-based cationic compounds such as a dicyandiamide-polyethyleneamine copolymer; 6) epichlorohydrin-dimethylamine copolymers; 7) diallyldimethyl ammonium-S0₂ polycondensation products; 8) diallylamine salt-SO₂ polycondensation products; 9) diallyl dimethyl ammonium chloride polymers; 10) diallyl dimethyl ammonium chloride-acrylamide copolymers; 11) copolymers of allylamine salts; 12) dialkylaminoethyl (meth)acrylate quaternary salt copolymers; 13) acrylamide-diallylamine copolymers; and 14) cationic compounds such as cationic resins having a five-membered cyclic amidine structure.

Among these, at least one selected from the group consisting of diallyl dimethyl ammonium chloride polymers, diallyl dimethyl ammonium chloride-acrylamide copolymers, hydrochloride salts of acrylamide-diallylamine copolymer, dicyandiamide-polyethyleneamine copolymers, and cationic resins having a five-membered cyclic amidine structure is preferably used, because such a use enhances printing density, suppresses the generation of bleeding, realizes uniform coloring and sharp and high-definition image. Both water-soluble polymers and water-soluble latex particles of these polymeric compounds are preferably used.

The molecular weight of the cationic polymeric compound is preferably 2,000 to 400,000. When the molecular weight is 2,000 or greater, the glossiness tends to be improved at a time of conducting cast-processing. When the molecular weight is 400,000 or less, tendencies in which the wetting liquid is difficultly infiltrated and the water-resistance of a printed portion is deteriorated can be suppressed.

On the other hand, as the ink fixing agent, a cationic compound with a low-molecular weight can be also used. Examples of the cationic compound with a low-molecular weight include cationic surfactants having 12 or greater carbon atoms, water-soluble polyvalent metallic salts, and the like. Examples of the cationic surfactant include stearic acid ammonium chloride, oleic acid ammonium chloride, and the like. Examples of the water-soluble polyvalent metallic salts include aluminum chloride, polyaluminium chloride, aluminium sulfite, zinc sulfate, magnesium chloride, magnesium nitrate, alum, and the like.

These ink fixing agents may be used alone or in combination. In particular, it is preferable that the ink fixing agent with a high-molecular weight be used as the main component and the small amount of the cationic compound with a low-molecular weight be used therewith, because such use can make large amounts of the ink fixing agent present near the surface of the ink-reeve side of the recording sheet, and can make the ink fixing agent present in the layer in such a distribution manner that the content thereof decreases in the thickness direction from the surface of the layer.

Although the ink fixing agent is mainly formulated in the wetting liquid, the ink fixing agent may also be formulated in the coating liquid for the undercoating layer or the coating liquid for the ink-receptive layer, because the water-resistance at a printing portion tends to deteriorate, in the case where the coating amount of the undercoating layer or ink-receptive layer is so great that the ink fixing agent contained in the wetting liquid is difficult to infiltrate inside the undercoating layer or ink-receptive layer. Although the content of the ink fixing agent in the coating liquid for the undercoating layer or the coating liquid for the ink-receptive layer is not particularly limited, it is preferable that the content be less than 25% by mass of the whole cationic compound contained in the ink-receptive layer of the ink jet recording sheet.

When a release agent is used, the release agent may be contained in the wetting liquid or the coating liquid for the ink-receptive layer, or alternatively applied on a specular drum. Every procedure is preferably used, because excellent releasability from the metal surface is realized. Although these procedures may be adopted in combination, the procedure in which the release agent is contained in the wetting liquid is particularly preferable among the procedures, because even a small amount of the release agent can exhibit effects thereof.

Examples of the release agent include higher fatty acid esters such as potassium stearate, and the like; higher fatty acid amides such as stearic acid amide, oleic acid amide, and the like; polyolefin waxes such as polyethylene wax, oxidized polyethylene wax, polypropylene wax, and the like; alkaline salts of higher fatty acid such as calcium stearate, zinc stearate, potassium oleate, ammonium oleate, and the like; silicone compounds such as lecithin, silicone oil, silicone wax, and the like; and fluorine compounds such as polytetrafluoroethylene, and the like.

Among these, the higher fatty acid amide is preferable, because it significantly improves the releasability from the specular drum, and prevents occurrence of bleeding of a printed image. In particular, such effects are significantly exhibited when a cationic compound is contained in the ink-receptive layer or the wetting liquid.

When the release agent is contained in the wetting liquid, the content thereof is adjusted to be within a range between 0.05 and 20% by mass, preferably 0.1 and 10% by mass, and more preferably 0.1 and 5% by mass, of the wetting liquid. When the release agent is contained in the ink-receptive layer, the content thereof is adjusted to he within a range between 0.1 and 50 parts by mass, preferably 0.3 and 30 parts by mass, and more preferably 0.5 and 20 parts by mass, with respect to 100 parts by mass of pigment. When the content is extremely small, there is a case in which the effect of improving the releasability is difficult to exhibit. When the content is extremely high, there is a case in which deterioration of the glossiness, cissing of ink, and decrease of printing density occur.

In the wetting liquid, a preservability-improver may be formulated so as to improve the storage durability at a time of recording. Examples of the preservability-improver include water-soluble polyvalent metallic salts of aluminium compounds such as polyaluminium chloride, zirconium compounds such as ammonium zirconium carbonate, or zirconium acetate, or the like; sulfur-containing compounds such as bis[2-(2-hydroxyethylthio)ethyl]sulfone, 2-(phenylthio)ethanol, and the like; ultraviolet absorbers such as benzotriazole, ceric oxide, and the like; radical scavengers such as hindered amine compounds, and the like; antioxidants such as vitamin C, vitamin E, dibutylhydroxy toluene, rutin, and the like. Among these, bis[2-(2-hydroxyethylthio)ethyl]sulfone is preferable, because it improves the light-resistance of an image printed using an ink jet printer. Although these preservability-improvers may be formulated in the coating liquid for the undercoating layer, the coating liquid for the ink-receptive layer, or the like, it is preferable that the improvers be contained in the wetting liquid, because the highest effects are exhibited.

Moreover, in the wetting liquid, various additives such as synthesized resin latexes such as styrene-butadiene latex, methyl methacrylate-butadiene copolymer latex, or the like, proteins such as casein, soy-bean protein, synthesized protein, or the like, various starches such as starch, oxidized starch, or the like, cellulose derivatives such as polyvinyl alcohol, carboxymethyl cellulose, methyl cellulose, or the like, various thickeners or flow-modifiers such as polycarboxylic acid, polyacrylic acid, acryl emulsion, polyamide, polyester, alkali thickeners, nonionic surfactants, or the like, ammonium salts or metallic salts of inorganic acid or organic acid, such as sodium chloride, ammonium chloride, sodium sulfate, potassium sulfate, ammonium sulfate, sodium nitrate, ammonium nitrate, sodium primary phosphate, ammonium phosphate, sodium polyphosphate, sodium hexametaphosphate, sodium formate, ammonium formate, sodium acetate, potassium acetate, sodium monochloroacetate, sodium malonate, sodium tartrate, potassium tartrate, potassium citrate, sodium lactate, sodium gluconate, sodium adipate, sodium dioctyl sulfosuccinate, sodium aluminate, or the like, low-molecular amines such as methylamine, diethanolamine, diethylenetriamine, diisopropylamine, triethanolamine, ethanolamine, or the like, phosphoric acid esters such as phosphoric acid ester, polyoxyethylene alkylphenolether phosphoric acid ester salts, polyoxyethylene ether phosphoric acid ester salts, alkylphenol ether phosphoric acid ester salts, or the like, polyoxyethylene, alkylether, polyoxyethylene, ammonia water, polyfunctional epoxy compounds such as diglycerol polyglycidyl ether, glycerol polyglycidyl ether, polyethylene glycol diglycidyl ether, polypropylene glycol diglycidyl ether, or diglycidyl adipate, or the like, various water-resistant-additives or printability-improvers such as urea-formaldehyde based, polyamide-epichlorohydrin based, glyoxal, or the like, may be formulated in an amount of 0.05 to 10% by mass, preferably 0.1 to 5% by mass, as needed, so as to adjust the coating amount or the like.

Moreover, various auxiliaries such as a dispersing agent antifoamer, coloring agent, fluorescent dye, antistatic agent, antiseptic agent, or the like may also be suitably added to the wetting liquid. As the auxiliaries, pigments such as alumina, noncrystalline silica, colloidal silica, clay, calcium carbonate, or the like may be added.

The wetting liquid may be applied plural times. By plural applications, the combination of the additives that are agglomerated by being mixed together can be applied as the wetting liquid. The application procedure is not particularly limited, and various known coating devices such as a blade coater, air-knife coater, roll coater, brush coater, champflex coater, bar coater, lip coater, gravure coater, curtain coater, slot die coater, slide coater, spray, or the like may be used. Also, the wetting liquid way be applied at a nip portion where the coating layer of the coating liquid for the ink-receptive layer is brought into contact and press to a heated specular drum.

A third aspect of the present invention provides a method for producing an ink jet recording sheet characterized in that a coating liquid containing at least both a temperature-sensitive polymeric compound and a pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity, is applied onto either an air-permeable support or at least one undercoating layer provided on the air-permeable support, in the temperature region where the temperature-sensitive polymeric compound exhibits hydrophobicity, to form a coating layer of the coating liquid; followed by bringing the temperature of the coating layer to the temperature region where the temperature-sensitive polymeric compound exhibits hydrophilicity to increase the viscosity of the coating layer or gelate the coating layer; drying to form an ink-receptive layer; applying a surface layer-wetting coating liquid containing colloidal particles and an ink fixing agent onto the ink-receptive layer; and Men bringing the assembly into contact and press to a heated specular surface and drying to form a surface layer.

When printing using a dye-type ink jet ink is conducted on an ink jet recording sheet prepared in accordance with the production method, high printing density is realized, as a result of which an image with bright colors is printed. Although the reason for this is not necessarily clear, it is assumed that impartion of the ink fixing agent by the surface layer-wetting coating liquid allows large amounts of ink fixing agent to be present near the surface of the ink-receptive side of the recording sheet and also allows the ink fixing agent to be present in such a distribution manner that the content thereof decreases in the thickness direction from the surface of the layer, as a result of which most of the ink dye provided at a time of printing using a dye-type ink jet ink is held near the surface of the ink-receptive layer. In particular, it is preferable that at least 75% by mass of the whole ink fixing agent contained in the ink-receptive layer be imparted by the surface layer-wetting coating liquid, because the above-mentioned effects are significantly exhibited. When the proportion of the ink fixing agent imparted by the surface layer-wetting coating liquid is less than 75% by mass, it tends to become difficult to hold most of the ink dye provided at a time of printing using a dye-type ink jet ink near the surface of the layer, as a result of which the printing density decreases, and brightness of colors deteriorates.

In addition to the above, it is assumed that the coating surface with extremely high smoothness and high glossy texture can be formed by applying the coating liquid containing at least both the temperature-sensitive polymeric compound and the pigment. The temperate-sensitive polymeric compound having the temperature region where the temperature-sensitive polymeric compound exhibits hydrophobicity and the temperature region where the temperature-sensitive polymeric compound exhibits hydrophilicity, the coating liquid becoming more viscous or gelating in the temperature region where the temperature-sensitive polymeric compound exhibits hydrophilicity, in the temperature region where the temperature-sensitive polymeric compound exhibits hydrophobicity to form the coating layer of the coating liquid, bringing the temperature of the coating layer to the temperature region where the temperature-sensitive polymeric compound exhibits hydrophilicity to increase the viscosity of the coating layer or gelate the coating layer, drying to form an ink-receptive layer, and then applying the surface layer-wetting coating liquid containing colloidal particles onto the ink-receptive layer. In accordance with the method, cracking of the ink-receptive layer is prevented by increasing the viscosity of the coating liquid or gelating the coating liquid, the caking being generally caused by shrinkage caused by moisture change at a time of drying. Also, the deterioration of the smoothness is prevented, because uneven swelling is prevented by increasing the viscosity of the coating liquid or gelating the coating liquid by merely changing the temperature without applying a cross-linking agent or the like. Also, the ink-receptive layer is not excessively hardened, because a cross-linking agent such as a boron-containing compound or the like is not contained. Accordingly, the coating layer is prevented from folding, and weakening under low humidity conditions.

It is assumed that the coating surface with high glossy texture can be realized as a result of forming the surface layer with excellent transparency and smoothness by applying the surface layer-wetting coating liquid containing colloidal particles on the ink-receptive layer. It is assumed that by realizing both the effect in which the coating surface with high glossy texture is formed and the effect of holding most of the ink dye near the surface of the coating layer, high printing density can be realized, and thereby an image with bright colors can be printed.

A fourth aspect of the present invention provides an ink jet recording sheet characterized by including: an ink-receptive layer formed by applying a coating liquid containing at least both a temperature-sensitive polymeric compound and a pigment, the temperature-sensitive polymeric compound having a temperature region where the temperature-sensitive polymeric compound exhibits hydrophobicity and a temperate region where the temperature-sensitive polymeric compound exhibits hydrophilicity, the coating liquid becoming more viscous or gelating in the temperature region where the temperature-sensitive polymeric compound exhibits hydrophilicity, onto either a support or at least one undercoating layer provided on the support, in the temperature region where the temperature sensitive polymeric compound exhibits hydrophobicity, to form a coating layer of the coating liquid, bringing the temperature of the coating layer to the temperature region where the temperature-sensitive polymeric compound exhibits hydrophilicity to increase the viscosity of the coating layer or gelate the coating layer, and then dying; and a surface layer containing colloidal particles, the surface layer being formed on the ink-receptive layer, in which an ink fixing agent is contained in the ink-receptive layer and the surface layer, and the content of the ink fixing agent in the surface-layer-side of the ink-receptive layer is greater than the support-side of the ink receptive layer.

The ink jet recording sheet with such a constitution can be produced in accordance with the above-mentioned method, for example, and has high glossiness, and, at a time of recording using a dye ink, realizes high printing density, prevents generation of printing bleeding, and realizes excellent ink-dot roundness, and thereby an image with high-definition can be printed, and realizes uniform printing, favorable scratch-resistance, and excellent recording suitability at a time of recording using a pigment ink, and thus is extremely and highly practical.

In the following, merely components of the third and fourth aspects different from those of the first and second aspects will be explained in detail.

“Surface Layer”.

Instead of the above-mentioned wetting liquid, the surface layer-wetting coating liquid containing colloidal particles and an ink fixing agent is applied on the ink-receptive layer to form the surface layer. In the surface layer-wetting coating liquid, an adhesive may be formulated, as needed. The surface layer is a coating layer that enhances the surface glossiness, rapidly fixes a dye or pigment containing an ink, realizes high color development (high printing density), and produces a uniform image. In particular, it is preferable that a glossy finish be performed to form the surface layer by bringing it in a wet state into contact and press to a heated specular roll after applying the surface layer-wetting coating liquid or at the same time as applying the surface layer-wetting coating liquid.

“Ink Fixing Agent”.

As the ink fixing agent, low-molecular cationic compounds exemplified in the following may also be used in addition to the cationic polymeric compounds exemplified as the ink fixing agent available for the wetting liquid. Examples of the low-molecular cationic compound include cationic surfactants having 12 or more carbon atoms, and water-soluble polyvalent metallic salts. Examples of the cationic surfactants include alkyltrimethyl ammonium halide, quaternary ammonium salts of alkylpyridinium halide, and the like. As the water-soluble polyvalent metallic salts, aluminium sulfate, zinc sulfate, magnesium chloride, magnesium nitrate, alum, or the like may be used. Also, polyaluminium chloride, which is a compound containing a polyvalent metal, may be used for this purpose.

These cationic compounds may also be used alone or in combination. In particular, the use of a small amount of low-molecular cationic compound together with the cationic polymeric compound contained as the main component facilitates large amounts of cationic compound to exist near the surface of the ink-receptive side of the recoding sheet and the cationic compound to exist in the layer in such a distribution manner that the content thereof decreases in the thickness direction from the surface of the layer, and thus the use is preferable.

Although the ink fixing agent may be formulated in the coating liquid for the undercoating layer or the coating liquid for the ink-receptive layer, it is preferable that 75% or greater of the whole ink fixing agent contained in the whole printing surface (undercoating layer, ink-receptive layer, and surface layer) be imparted by the surface layer-wetting coating liquid, because the printing density becomes high.

“Colloidal Particle”.

Examples of the colloidal particles contained in the surface layer include colloidal particles of the fine pigments or colloidal silicas, exemplified as examples for forming the above-mentioned ink-receptive layer, and specifically, at least one is selected from fumed silica, mesoporous silica, and colloidal matter of wet silica, prepared by condensing active silica, colloidal silica, alumina oxide, and alumina hydrate. Among these, colloidal silica fumed silica, and alumina oxide can realize excellent luster, and thus are preferable.

Although the form of the colloidal particles may be a monodispersion form, or agglomerated particulate dispersion form, the monodispersion form or the agglomerated particulate dispersion form with small particle diameter is mainly preferably contained in the surface layer so as to realize high printing density and luster. In the case of the monodispersion form (for example, colloidal silica), it is preferable that the average y particle diameter be 3 to 100 nm, and more preferably 10 to 80 nm. In the case of the agglomerated particulate dispersion form, a fine pigment with the average primary particle diameter of 3 to 70 nm, more preferably 5 to 40 nm, and the average secondary particle diameter of 700 nm or less, and more preferably 400 nm or less is preferable. In the case of the monodispersion form, a spherical pigment is preferably used.

The colloidal particles have uniform particle diameter and shape, and thus are preferably used for the surface layer-wetting coating liquid. As the colloidal silica, a monodispersed colloidal silica with an average pi particle diameter of 0.003 to 0.1 μm, alumina with an average secondary particle diameter of less than 0.07 μm, alumina hydrate with an average secondary particle diameter of less than 1 μm, fumed silica with an average secondary particle diameter of 0.7 μm or less, and wet silica gel with an average secondary particle diameter of 0.4 μm or less are preferable.

In the present invention, since the ink fixing agent is contained in the surface layer-wetting coating liquid, a cationic fine pigment is particularly preferable. In particular, fumed alumina oxide and cationic colloidal silica are preferably used. When an anionic silica or the like is used as a pigment, the silica is preferably used as a cationic fine pigment by mixing to agglomerate the silica with the ink fixing agent, as exemplified as examples for forming the above-mentioned ink-receptive layer, followed by pulverizing the agglomerated silica-ink fixing agent particles to the size within the above-mentioned average particle diameter.

The content of the ink fixing agent is adjusted to approximately 1 to 500 parts by mass, preferably 5 to 200 parts by mass, and more preferably 10 to 100 parts by mass, with respect to 100 parts by mass of the colloidal particles. When the content is 1 part by mass or greater, it becomes easy to apply 75% by mass or greater of the whole ink fixing agent contained in the ink jet recording sheet. When the content is 500 parts by mass or less, it is possible to suppress the tendency in which the coating amount is so great that air gaps in the ink-receptive layer are covered and thereby the ink-absorption deteriorates.

“Formation of Surface Layer”

When colloidal silica is used as the colloidal particles, the surface layer-wetting coating liquid may be applied without containing any adhesives, but the surface layer-wetting coating liquid usually further contains an adhesive. As the adhesive, well-known adhesives used for an ink jet recording sheet may be used. For example, polyvinyl alcohols such as polyvinyl alcohol, cationic-modified polyvinyl alcohol, silyl-modified polyvinyl alcohol, or the like, casein, soy-bean protein, synthesized proteins, starch, cellulose derivatives such as carboxymethyl cellulose, methyl cellulose, or the like, vinyl acetate-based polymer emulsion, styrene-butadiene copolymer emulsion, ethylene-vinyl acetate copolymer emulsion, acryl-based copolymer emulsion, styrene-acryl-based copolymer emulsion, aqueous acrylate resins, aqueous polyurethane resins, and aqueous polyester resins, or other adhesives conventionally and generally known in the art of coated sheets may be used alone or in combination. Since the ink fixing agent is formulated in the surface layer-wetting coating liquid under the present invention, a cationic-modified adhesive is particularly preferable.

When a glossy finish is applied using a heated specular roll after applying the surface layer-wetting coating liquid, it is preferable that the glass transition temperature of the adhesive to be used be −20° C. or higher, more preferably 40° C. or higher, and even more preferably 60° C. or higher. When the glass transition temperature is −20° C. or higher, it is possible to suppress the tendency in which the ink-absorption of ink jet printer easily deteriorates. Also, it is possible to suppress the deterioration of the releasability of the surface layer from the mirror-finished metal surface at a time of conducing high-gloss finish by bringing the layer into contact and press to the heated mirror-finished metal surface preferably to dry, while the surface layer is in a wet state. Although there is no particular upper limit of the glass transition temperature, it is generally preferable that the glass transition temperature be 150° C. or lower. When the glass transition temperature exceeds 150° C., the surface layer becomes brittle, as a result of which there may occur problems due to lack of strength, such as increased dust generated at a time of cutting, disaggregation of the surface layer from a creased portion, or the like.

It is often effective depending on required characteristics to combine at least two kinds of adhesives with different glass transition temperatures. Although the reason for this is not clear, it is assumed that the adhesive with a low glass transition temperature and the adhesive with a high glass transition temperature are not uniformly mixed, but constitute a sea/island structure, as a result of which characteristics of each adhesive are more effectively realized. When at least two kinds of adhesive are combined, it is preferable that at least one of the two be a resin with a glass transition point of −20° C. or higher.

The content ratio (solid-content mass ratio) of the adhesive to the pigment contained in the surface layer-wetting coating liquid is preferably equal to or less ha 100 parts by mass, more preferably within a range between 2 to 50 parts by mass, and even more preferably 5 to 40 parts by mass, with respect to 100 parts by mass of the pigment. When the content ratio of the adhesive is equal to or less than 100 parts by mass, the deterioration of the ink absorbability can be prevented.

Moreover, the surface layer-wetting coating liquid may contain a preservability-improver so as to improve storage durability of a recorded image. As the preservability-improver, the same as those exemplified as the preservability-improver formulated in the above-mentioned wetting liquid may be used. Although the preservability-improver may be formulated in the coating liquid for the undercoating layer or the coating liquid for the ink-receptive layer, formulation thereof in the surface layer-wetting coating liquid exhibits highest effects, and thus is preferable.

Moreover, in the surface layer-wetting coating liquid, various auxiliaries used for a general coated printing sheet or ink jet recording sheet, such as a pigment, antifoamer, coloring agent, fluorescent whitening agent, antistatic agent, antiseptic agent, dispersing agent, or thickener, may be suitably formulated to adjust whiteness degree, viscosity, flowability, or the like.

In order to apply the surface layer-wetting coating liquid, me coating devices exemplified as those used for applying the wetting liquid may be used. Among these, an air-knife coater, lip coater, slide coater, curtain coater, or slot die coater is preferably used. When these coating devices are used, the glossy texture of the coating layer tends to be more favorable, probably because the coating layer can be formed with uniform thickness without being influenced by minute roughness formed on an air-permeable base material or undercoating layer, and an ink-receptive layer.

Moreover, it is preferable that the surface layer be formed following the application and drying of the coating liquid for the ink-receptive layer using the same device. In the case of this procedure, there is no need to roll up the sheet where the ink-receptive layer is coated, and thereby, the ink-receptive layer is prevented from changing depending on the difference in pressure between a portion near the centre core and a portion near the surface at a time of rolling up, and so the ink-receptive layer and the surface layer, which are uniform in a direction of the manufacturing stream, can be formed.

It is preferable that the coating amount of the surface layer be within a range from 0.1 to 10 g/m², more preferably 0.2 to 5 g/m², and even more preferably 0.5 to 3 g/m². When the coating amount is 0.1 g/m² or greater, the tendency in which the coating layer becomes thin thereby easily generating color interference by light can be suppressed. In contrast, when the coat amount is 10 g/m² or less, the tendency in which the rate of ink-absorption easily deteriorates can be suppressed.

“Finish with Specular Roll”

In the present invention, it is particular preferable that the glossiness be imparted by a so-called casting method in which the surface layer in a wet state is brought into contact and press to a heated mirror-finished metal surface (of a specular roll, for example) and dried to give a high-glossy texture to the ink jet recording sheet, because the most favorable glossiness can be realized. In particular, the glossiness is significantly improved by an application procedure in which the surface layer is formed by applying the surface layer-wetting coating liquid forming a reservoir between the ink-receptive layer and a specular roll at a nip portion between the specular roll and a press roll, followed by bringing the surface layer into contact and press to the heated mirror-finished metal surface while the surface layer is in a wet state. Accordingly, the application procedure is particularly preferable.

Moreover, a humidity-controlling area may be provided so as to straighten the curling of the obtained ink jet recording sheet after drying.

The surface temperature of the metal surface of the specular roll or the like is preferably within a range from 80 to 120° C. When the surface temperature of the metal surface is lower than 80° C., the drying efficiency is not good, and there is a possibility in which the productivity deteriorates. In contrast, when the surface temperature is higher tan 120° C., there is a possibility in which bubbling of the surface layer-wetting coating liquid occurs due to sudden boiling on the metal surface, and the glossiness or printability deteriorates.

When the surface layer is brought, preferably to dry, into contact and press to the heated mirror-finished metal surface (specular roll), while the surface layer is in a wet state, so as to give a high-glossy texture to the recording material, a release agent is preferably added to the surface layer-wetting coating liquid so as to impart releasability from the mirror-finished metal surface or the like. The release agent may be coated on the specular roll in advance.

As the release agent the release agents exemplified as those available for the wetting liquid may be used, but the cationic release agents are preferably used in particular. The content of the release agent may be adjusted within the same range as that described in the wetting liquid. When the content is extremely small, there is a case in which the releasability is not improved. In contrasts when the content is extremely large, there is a case in which the glossiness deteriorates and cissing of ink or deterioration of printing density occurs.

There is a tendency in which the printing density increases in accordance with the increase of the transparency of the surface layer a the ink-receptive layer according to the present invention. It is preferable that the haze degree (JIS K 7105) of the surface layer be 30% or less, and the sum of the haze degrees of the surface layer and the ink-receptive layer be 50% or less. It is more preferable that the haze degree of the surface layer be 15% or less, and the sun of the haze degrees of the surface layer and the ink-receptive layer be 30% or less.

### EXAMPLES

In the following, the present invention will be explained in more detail by illustrating examples. However, it is apparent that the scope of this present invention is not limited to these. Also, “parts” and “%” used in the examples indicate “parts by mass” and “% by mass” unless otherwise so indicated.

(Preparation of Air-Permeable Support (Paper Substrate))

After a paper substrate with a base weight of 188 g/m² was produced with a Fourdrinier paper making machine by using papermaking materials composed of 100 parts of a wood pulp (LBKP: with a freeness of 440 ml C.S.F,), 15 parts of filler (ratio of calcium carbonate to talc is 3 to 1), 0.05 parts of a commercially available sizing agent (manufactured by National Starch & Chemical Co., under the trade name of FIVERAN-81K), 0.45 parts of aluminum sulfate, 0.45 parts of starch, 0.4 parts of polyamide-epichlorohydrin resin as a paper-reinforcing agent, and a small amount of yield improving agent, the paper substrate was subjected to supercalender treatment at a linear pressure of 150 kg/cm.

The obtained paper substrate had a thickness of 210 μm and an air-permeability of 30 seconds, and did not contain any ink fixing agents.

(Preparation of Fine Pigment)

Fine pigments A to G having the following components and characteristics were prepared.

“Preparation of Fine Pigment A”

A fumed silica with an average particle diameter of 1.0 μm (manufactured by NIPPON AEROSIL CO., LTD., under the trade name of AEROSIL A300, with an average primary particle diameter of approximately 0.008 μm) was dispersed using a homomixer, pulverized and dispersed using a high speed colliding type homogenizer until the avenge particle diameter became 0.15 μm and then a 10% aqueous dispersion was prepared.

“Preparation of Fine Pigment B (Containing an Ink Fixing Agent)”

A fumed silica with an average particle diameter of 1.0 μm (manufactured by NIPPON AEROSIL CO., LTD., under the trade name of AEROSIL A300, with an average primary particle diameter of approximately 0.008 μm) was dispersed using a homomixer, pulverized and dispersed using a high speed colliding type homogenizer until the average particle diameter became 0.08 μm, and then a 10% aqueous dispersion was prepared.

To 100 parts of the dispersion, 10 parts of ink fixing agent (cationic compound having a five-membered cyclic amidine structure, manufactured by HYMO Co., Ltd., under the trade name of HYMAX SC-700M) was added, and further dispersed using a high speed colliding type homogenizer to prepare a 10% aqueous dispersion with an average particle diameter of 0.15 μm. The content ratio of the ink fixing agent was 9.1% by mass of the whole solid content.

“Preparation of Fine Pigment C (Containing an Ink Fixing Agent)”

A commercially available fumed silica (manufactured by TOKUYAMA Corp., under the trade name of REOLOSIL QS-30, with an average primary particle diameter of 0.009 μm and specific surface area of 300 m²/g) was repeatedly pulverized, dispersed, and classified, and then a 10% silica dispersion with an average secondary particle diameter of 0.08 μm was prepared.

To 100 parts of the dispersion, diallyl dimethyl ammonium chloride-acrylamide copolymer (manufactured by Nitto Boseki Co., Ltd., under the trade name of PAS-J-81) was added as an ink fixing agent, and a 10% aqueous dispersion with an average particle diameter of 0.08 μm was prepared by the same way as that described in the preparation of the Fine pigment B, and thus a cationic fine pigment was obtained.

“Preparation of Fine Pigment D (Containing an Ink Fixing Agent)”

A high-purity alumina with an average particle diameter of approximately 3.0 μm (manufactured by Sumitomo Chemical Co., Ltd., under the trade name of AKP-G015, γ-alumina, with an average primary particle diameter of approximately 0.1 μm) was dispersed using a homomixer, dispersed using a high speed colliding type homogenizer, repeatedly pulverized and dispersed using a liquid-colliding type homogenizer until the average particle diameter became 0.9 μm, and then a 10% aqueous dispersion was prepared.

To 100 parts of the dispersion, 10 parts of diallyl dimethyl ammonium chloride-acrylamide copolymer (manufacture by Nitto Boseki Co., Ltd., under the trade name of PAS-J-81) was added as an ink fixing agent, and a 10% aqueous dispersion with an average particle diameter of 0.9 μm was prepared by the same way as that described in the preparation of the Fine pigment B, and thus a cationic fine pigment was obtained.

“Preparation of Fine Pigment E (Containing an Ink Fixing Agent)”

A high-purity alumina with an average particle diameter of approximately 3.0 μm (manufactured by Sumitomo Chemical Co., Ltd., under the trade name of AKP-GO15, γ-alumina, with an average primary particle diameter of approximately 0.1 μm) was dispersed using a homomixer, dispersed using a high speed colliding type homogenizer, repeatedly pulverized and dispersed using a liquid-colliding type homogenizer until the average particle diameter became 0.4 μm, and then a 10% aqueous dispersion was prepared.

To 100 parts of the dispersion, 10 parts of diallyl dimethyl ammonium chloride-acrylamide copolymer (manufactured by Nitto Boseki Co., Ltd., under the trade name of PAS-J-81) was added as an ink fixing agent, and a 10% aqueous dispersion with an average particle diameter of 0.4 μm was prepared by the same way as that described in the preparation of the Fine pigment B, and thus a cationic fine pigment was obtained.

“Preparation of Fine Pigment F (Containing an Ink Fixing Agent)”

A fine alumina hydrate with an average particle diameter of approximately 5 μm (manufactured by CATALYSTS & CHEMICALS IND. CO., LTD., under the trade name of AS-3) was dispersed using a homomixer, dispersed using a high speed colliding type homogenizer, repeatedly pulverized and dispersed using a liquid-colliding type homogenizer until the average particle diameter became 0.5 μm, and then a 10% aqueous dispersion was prepared.

To 100 parts of the dispersion, 10 parts of diallyl dimethyl ammonium chloride-acrylamide copolymer (manufactured by Nitto Boseki Co., Ltd., under the trade name of PAS-J-81) was added as an ink fixing agent, and a 10% aqueous dispersion with an average particle diameter of 0.5 μm was prepared by the same way as that described in the preparation of the Fine pigment B, and thus a cationic fine pigment was obtained.

“Preparation of Fine Pigment G (Containing an Ink Fixing Agent)”

A fumed silica (man d by NIPPON AEROSIL CO., LTD., under the trade name of AEROSIL A300, with an average primary particle diameter of 0.008 μm) was dispersed using a homomixer, pulverized and dispersed using a high speed colliding type homogenizer until the average particle diameter became 0.08 μm, and then a 10% aqueous dispersion was prepared.

To 100 parts of the dispersion, 10 parts of diallyl dimethyl ammonium chloride-acrylamide copolymer (manufactured by Nitto Boseki Co., Ltd., under the trade name of PAS-J-81) was added as an ink fixing agent, and a 10% aqueous dispersion with an average particle diameter of 0.08 μm was prepared by the same way as that described in the preparation of the Fine pigment B, and thus a cationic fine pigment was obtained.

(Preparation of Coating Liquid for Undercoating Layer)

Coating liquids A to G for the undercoating layer, having the following components and characteristics, were prepared.

“Preparation of Coating Liquid A for Undercoating Layer”

100 parts of synthesized noncrystalline silica (manufactured by TOKUYAMA Corp., under the trademark of FINESEAL X-60, with an average secondary particle diameter of 6.2 μm); 25 parts of silyl-modified polyvinyl alcohol (manufactured by KURARAY CO., LTD., under the trade name of R1130); and 2 parts of fluorescent dye (manufactured by Sumitomo Chemical Co., Ltd., under the trademark of WHITEX BPS (H)). Solid content was 15%.

“Preparation of Coating Liquid B for Undercoating Layer (Containing an Ink Fixing Agent)”

100 parts of synthesized noncrystalline silica (manufactured by TOKUYAMA Corp., under the trademark of FINESEAL X-60, with an average secondary particle diameter of 6.2 μm); 25 parts of silyl-modified polyvinyl alcohol (manufactured by KURARAY CO., LTD., under the trade name of R1130); 2 parts of fluorescent dye (manufactured by Sumitomo Chemical Co., Ltd., under the trademark of WHITEX BPS (H)); and 3 parts of ink fixing agent (cationic compound having a five-membered cyclic amidine structure, manufactured by HYMO Co., Ltd., under the trade name of HYMAX SC-700M. Solid content was 15%. The content ratio of the ink fixing agent was 2.3% by mass of the whole solid content.

“Preparation of Coating Liquid C for Undercoating Layer (Containing an Ink Fixing Agent)”

100 parts of synthesized noncrystalline silica (manufactured by TOKUYAMA Corp., under the trademark of FINESEAL X-60, with an average secondary particle diameter of 6.2 μm); 25 parts of silyl modified polyvinyl alcohol (manufactured by KURARAY CO., LTD., under the trade name of R1130); 2 parts of fluorescent dye (manufactured by Sumitomo Chemical Co., Ltd., under the trademark of WHITEX BPS (H)); and 5 parts of ink fixing agent (cationic compound having a five-membered cyclic amidine structure, manufactured by HYMO Co., Ltd., under the trade name of HYMAX SC-700M). Solid content was 15%. The content ratio of the ink fixing agent was 3.8% by mass of the whole solid content.

“Preparation of Coating Liquid D for Undercoating Layer”

100 parts of the above-mentioned Fine pigment A; 25 parts of polyvinyl alcohol (manufactured by KURARAY CO., LTD., under e trade name of PVA140); and 2 parts of fluorescent dye (manufactured by Sumitomo Chemical Co., Ltd., under the trademark of WHITEX BPS (H)). Solid content was 15%.

“Preparation of Coating Liquid E for Undercoating Layer”

100 parts of synthesized noncrystalline silica (manufactured by TOKUYAMA Corp., under the trademark of FINESEAL X-45, with an average secondary particle diameter of 4.5 μm); 25 parts of silyl-modified polyvinyl alcohol (manufactured by KURARAY CO., LTD., under the trade name of R1130); and 2 parts of fluorescent dye (manufactured by Sumitomo Chemical Co., Ltd., under the trademark of WHITEX BPS (H)). Solid content was 15%.

“Preparation of Coating Liquid F for Undercoating Layer”

100 parts of synthesized noncrystalline silica (manufactured by TOKUYAMA Corp., under the remark of FINESEAL X45, with an average secondary particle diameter of 4.5 μm); 25 parts of silyl-modified polyvinyl alcohol (manufactured by KURARAY CO., LTD., under the trade name of R1130); 2 pars of fluorescent dye (manufactured by Sumitomo Chemical Co., Ltd., under the trademark of WHITEX BPS (H)); and 3 parts of a cationic compound having a five-membered cyclic amidine structure, used as an ink fixing agent (manufactured by HYMO Co., Ltd., under the trade name of HYMAX C-700M). Solid content was 15%. The content ratio of the ink fixing agent was 2.3% by mass of the whole solid content.

“Preparation of Coating Liquid G for Undercoating Layer (Containing an Ink Fixing Agent)”

100 parts of synthesized noncrystalline silica (manufactured by TOKUYAMA Corp., under the trademark of FINESEAL X45, with an average secondary particle diameter of 4.5 μm); 25 pars of silyl-modified polyvinyl alcohol (manufactured by KURARAY CO., LTD., under the trade name of R1130); 2 parts of fluorescent dye (manufactured by Sumitomo Chemical Co., Ltd., under the trademark of WHITEX BPS (H)); and 5 parts of diallyl dimethyl ammonium chloride-acrylamide copolymer, used as an ink fixing agent (manufactured by Nitto Boseki Co., Ltd., under the trade name of PAS-J-81). Solid content was 15%. The content ratio of the ink fixing agent was 3.8% by mass of the whole solid content.

(Preparation of Coating Liquid for Ink-Receptive Layer)

Coating liquids A to C for the ink-receptive layer, having the following components and characteristics, were prepared.

“Coating Liquid A for Ink-Receptive Layer”

100 parts of the above-mentioned Fine pigment A; 20 parts of temperature-sensitive polymeric compound (manufactured by Asahi Kasei Corporation under the trade name of ALB-A244, with a temperature-sensitive point of 24° C., anion); and 0.1 parts of antifoamer. Solid content was 10%. The tempenture at a time of mixing each component was 40° C.

“Coating Liquid B for Ink-Receptive Layer (Containing an Ink Fixing Agent)”

100 parts of the above-mentioned Fine pigment B (containing an ink fixing agent); 20 parts of a temperature-sensitive polymeric compound (manufactured by Asahi Kasei Corporation under the trade name of ALB-A221, with a temperate-sensitive point of 24° C., cation); and 0.1 parts of antifoamer. Solid content was 10%. The temperature at a time of mixing each component was 40° C. The content ratio of the ink fixing agent was 7.6% by mass of the whole solid content.

“Coating Liquid C for Ink-Receptive Layer”

100 parts of the above-mentioned Fine pigment A; 20 parts of polyvinyl alcohol (manufactured by KURARAY CO., LTD., under the trade name of PVA145); and 0.1 pars of antifoamer. Solid content was 10%.

(Preparation of Wetting Liquid)

Wetting liquids A and B, having the following components and characteristics, were prepared.

“Wetting Liquid A”

An aqueous solution containing 0.5% by mass of a release agent (polyethylene wax, nonion) was prepared.

“Wetting Liquid B (Containing an Ink Fixing Agent)”

An aqueous solution containing 4.5% by mass of ink fixing agent (cationic compound having a five-membered cyclic amidine structure, manufactured by HYMO Co., Ltd., under the trade name of HYMAX SC-700M) and 0.5% by mass of release agent (stearic acid amide, cation) were prepared. The content ratio of the ink fixing agent was 90% by mass of the whole solid content.

(Preparation of Coating Liquid for Surface Layer-Wetting Coating Liquid)

Surface layer-wetting coating liquids A to H, having the following components and characteristics, were prepared.

“Surface Layer-Wetting Coating Liquid A (without Containing any Ink Fixing Agents)”

100 parts of anionic colloidal silica with an average particle diameter of 0.05 μm (manufactured by NISSAN CHEMICAL INDUSTRIES, LTD., under the trademark of Snowtex OL) (colloidal particles); and 1 part of release agent (polyethylene wax, nonion). Solid content was 15%.

“Surface Layer-Wetting Coating Liquid B (Containing an Ink Fixing Agent)”

100 parts of cationic colloidal silica with an average particle diameter of 0.03 μm (manufactured by NISSAN CHEMICAL INDUSTRIES, LTD., under the trademark of Snowtex AK-L) (colloidal particles); 40 parts of a cationic compound having a five-membered ring-compound amidine structure, used as an ink fixing agent (manufactured by HYMO Co., Ltd., under the trade name of HYMAX SC-700M); and 1 part of release agent (polyethylene wax, nonion). Solid content was 15% The content ratio of the ink fixing agent was 28.4% by mass of the whole solid content.

“Surface Layer-Wetting Coating Liquid C (Containing an Ink Fixing Agent)”

100 parts of the above-mentioned Fine pigment C (colloidal particles); 40 parts of a cationic compound composed of a diallyl dimethyl ammonium chloride-acrylamide copolymer, used as au ink fixing agent (manufactured by Nitto Boseki Co., Ltd., under the trade name of PAS-J-81); and 1 pant of release agent (polyethylene wax, nonion). Solid content was 15%. The content ratio of the ink fixing agent was 28.4% by mass of the whole solid content.

”Surface Layer-Wetting Coating Liquid D (Containing an Ink Fixing Agent)”

100 parts of the above-mentioned Fine pigment D (colloidal particles); 40 parts of a cationic compound composed of a diallyl dimethyl ammonium chloride-acrylamide copolymer, used as an ink fixing agent (manufactured by Nitto Boseki Co., Ltd., under the trade name of PAS-J-81); and 1 part of release agent (polyethylene wax, nonion). Solid content was 15%. The content ratio of the ink fixing agent was 28.4% by mass of the whole solid content.

“Surface Layer-Wetting Coating Liquid E (Containing an Ink Fixing Agent)”

100 pats of the above-mentioned Fine pigment E (colloidal particles); 40 parts of a cationic compound having a five-membered cyclic amidine structure, used as an ink fixing agent (manufactured by HYMO Co., Ltd., under the trade name of HYMAX SC-700M); and 1 part of release agent (polyethylene wax, nonion). Solid content was 15%. The content ratio of the ink firing agent was 28.4% by mass of the whole solid content.

“Surface Layer-Wetting Coating Liquid F (Containing an Ink Fixing Agent)”

100 parts of the above-mentioned Fine pigment F (colloidal particles); 40 parts of a cationic compound composed of an acrylamide-diallylamine copolymer, used as an ink fixing agent (manufactured by Sumitomo Chemical Co., Ltd., under the trademark of SUMIREZ RESIN 1001); and I part of release agent (polyethylene wax, nonion). Solid content was 15%. The content ratio of the ink fixing agent was 28.4% by mass of te whole solid content.

“Surface Layer-Wetting Coating Liquid G (Containing an Ink Fixing Agent)”

100 parts of the above-mentioned Fine pigment G (colloidal particles); 40 parts of a cationic compound composed of a dicyandiamide-polyethyleneamine copolymer, used as an ink icing agent (manufactured by NICCA CHEMICAL CO., LTD., under the trade name of NEOFIX E-117); and 1 part of release agent (polyethylene wax, nonion). Solid content was 15%. The content ratio of the ink fixing agent was 28.4% by mass of the whole solid content.

“Surface Layer-Wetting Coating Liquid H (Containing an Ink Fixing Agent)”

100 parts of the above-mentioned Fine pigment D (colloidal particles); 40 parts of a cationic compound composed of a diallyl dimethyl ammonium chloride polymer, used as an ink fixing agent (manufactured by SENKA CORPORATION under the trade name of UNISENCE CP-102); and 1 part of release agent (polyethylene wax, nonion). Solid content was 15%. The content ratio of the ink fixing agent was 28.4% by mass of the whole solid content.

### Example 1

The above-mentioned Coating liquid A for the undercoating layer was applied on the air-permeable support using an air-knife coater at a dry mass of 6 g/m², and then dried, to form an undercoating layer.

After the surface temperature of the undercoating layer was adjusted to 23° C., the above-mentioned Coating liquid A for the ink-receptive layer was applied on the undercoating layer using a die coater at a coating temperature of 40° C. and a dry mass of 4 g/m². Then, the surface temperature was lowered to 20° C. using a cold air fan to gelate he coating layer. At this time, the moisture content of the coating layer was 22%. Then, the above-mentioned Wetting liquid B (containing an ink fixing agent) was applied on the coating layer at a nip portion where pressure was applied bete specular drums, and then immediately, the assembly was brought into contact and press to the specular drum of which the surface temperature was held at 100° C., and died, to produce an ink jet recording sheet. The dry mass of the applied wetting liquid was 0.5 g/m². The ink fixing agent was contained only in the wetting liquid.

### Example 2

An ink jet recording sheet was prepared in a manner similar to that of Example 1, except that the above-mentioned Coating liquid B for the undercoating layer (containing an ink fixing agent) was used. The dry mass of the applied wetting liquid was 0.6 g/m². The ink fixing agent was contained in the coating liquid for the undercoating layer and the wetting liquid, and the content ratio thereof in each liquid was 20% and 80%.

### Example 3

An ink jet recording sheet was prepared in a manner similar to hat of Example 1, except that the above-mentioned Coating liquid C for the undercoating layer (containing an ink fixing agent) was used. The dry mass of the applied wetting liquid was 0.6 g/m². The ink fixing agent was contained in the coating liquid for the undercoating layer and the wetting liquid, and the content ratio thereof in each liquid was 30% and 70%.

### Comparative Example 1

An ink jet recording sheet was prepared in a manner similar to that of Example 1, except that the above-mentioned Coating liquid B for the ink-receptive layer (containing an ink fixing agent) and Wetting liquid A were used. The dry mass of the applied wetting liquid was 0.1 g/m². The ink fixing agent was contained only in the coating liquid for the ink-receptive layer.

### Comparative Example 2

An ink jet recording sheet was prepared in a manner similar to that of Example 1, except that the above-mentioned Wetting liquid A was used. The dry mass of the applied wetting liquid was 0.1 g/m². No ink fixing agent was contained.

### Comparative Example 3

The above-mentioned Coating liquid A for the undercoating layer was applied on the air-permeable support using an air-knife coater at a dry mass of 6 g/m², and then dried to form an undercoating layer.

On the undercoating layer, the above-mentioned Coating liquid C for the ink-receptive layer was applied using a die coater at a dry mass of 4 g/m². At this time, the moisture content of the coating layer was 22%. Then, the above-mentioned Wetting liquid B (containing an ink fixing agent) was applied on the coating layer at a nip portion where pressure was applied between specular drums, and then immediately, the assembly was brought into contact and press to the specular drum of which the surface temperature was held at 100° C., and dried, to produce an ink jet recording sheet. The dry mass of the applied wetting liquid was 0.6 g/m². The ink fixing agent was contained only in the wetting liquid.

### Example 4

On the air-permeable support, the above-mentioned Coating liquid A for the undercoating layer was applied using an air-knife coater at a dry mass of 6 g/m², and then dried to form an undercoating layer.

After the surface temperature of the undercoating layer was adjusted to 23° C., the above-mentioned Coating liquid A for the ink-receptive layer was applied on the undercoating layer using a die coater at a coating temperature of 40° C. and a dry mass of 4 g/m². Then, the surface temperature was lowered to 20° C. using a cold air fan to gelate the coating layer. Then, the coating layer was dried using a hot air drier until the moisture content in the coating layer became 12%. Then, the above-mentioned Wetting liquid B (containing an ink fixing agent) was applied on the coating layer at a nip portion where pressure was applied between specular drums, and then immediately, the assembly was brought into contact and press to the specular drum of which the sure temperature was held at 100° C., and dried, to produce an ink jet recording sheet. The dry mass of the applied wetting liquid was 0.6 g/m². The ink fixing agent was contained only in the wetting liquid.

### Example 5

An ink jet recording sheet was prepared in a manner similar to that of Example 1, except that the above-mentioned Coating liquid D for the undercoating layer was applied using an air-knife coater at a dry mass of 12 g/m², and then dried to form an undercoating layer. The dry mass of the applied wetting liquid was 0/6 g/m². The ink fixing agent was contained only in the wetting liquid.

### Comparative Example 4

The above-mentioned Coating liquid A for the undercoating layer was applied on the air-permeable support using an air-knife coater at a dry mass of 6 g/m², and then dried to form an undercoating layer.

After the surface temperature of the undercoating layer was adjusted to 23° C., the above-mentioned Coating liquid B for the ink-receptive layer was applied on the undercoating layer using a die coater at a coating temperature of 40° C. and a dry mass of 4 g/m². The the surface was cooled to 20° C. using a cold air fan to gelate the coating layer. At this time, the moisture content of the coating layer was 23%. The coating layer was immediately brought into contact and press to the specular drum of which the surface temperature was held at 100° C., and dried, without being coated with the wetting liquid, and thus an ink jet recording sheet was produced. The ink fixing agent was contained only in the coating liquid for the ink-receptive layer.

### Example 6

The above-mentioned Coating liquid E for the undercoating layer (without containing any ink fixing agents) was applied on the air-permeable support using an air-knife coater at a dry mass of 6 g/m², and then dried to form an undercoating layer.

After the surface temperate of the undercoating layer was adjusted to 21° C., the above-mentioned Coating liquid A for the ink-receptive layer (without containing any ink fixing agents) was applied on the undercoating layer using a die coater at a coating temperature of 25° C. and a dry mass of 4 g/m². At this time, the moisture content of the coating layer was 22%. Then, the above-mentioned Surface layer-wetting coating liquid B (containing an ink fixing agent) was applied on the coating layer, and then immediately the assembly was brought into contact and press to a specular drum of which the surface temperature was held at 100° C., and dried, to produce an ink jet recording sheet. The dry mass of the applied surface layer-wetting coating liquid was 2 g/m². The ink fixing agent was contained only in the surface layer-wetting coating liquid.

### Example 7

An ink jet recording sheet was prepared in a manner similar to that of Example 6, except that the above-mentioned Coating liquid F for the undercoating layer (containing an ink fix agent) was used. The dry mass of the applied surface layer-wetting coating liquid was 2 g/m². The ink fixing agent was contained in the coating liquid for the undercoat layer and the surface layer-wetting coating liquid, and the content ratio thereof in each liquid was 20% and 80%.

### Example 8

An ink jet recording sheet was prepared in a manner similar to that of Example 6, except that the above-mentioned Coating liquid G for the undercoating layer (containing an ink fixing agent) was applied at a dry mass of 5 g/m². The dry mass of the applied surface layer-wetting coating liquid was 2.0 g/m². The ink fixing agent was contained in the coating liquid for the undercoating layer and the surface layer-wetting coating liquid, and the content ratio thereof in each liquid was 30% and 70%.

### Example 9

An ink jet recording sheet was prepared in a manner similar to that of Example 6, except that the above-mentioned Surface layer-wetting coating liquid C (containing an ink fixing agent) was used. The dry mass of the applied surface layer-wetting coating liquid was 2 g/m². The ink fixing agent was contained only in the surface layer-we g coating liquid.

### Examples 10 to 15

The above-mentioned Coating liquid E for the undercoating layer (without containing any ink fixing agents) was applied on the air-permeable support using an air-knife coater at a dry mass of 20 g/m², and hen dried to form an undercoating layer.

After the surface temperature of the undercoating layer was adjusted to 19° C., the above-mentioned Coating liquid A for the ink-receptive layer (without containing any ink fixing agents) was applied on the undercoating layer using a die coater at a coating temperature of 25° C. and a dry mass of 3 g/m². Then, each of the above-mentioned Surface layer-wetting coating liquids C to H (containing an ink fixing agent) was applied, and then immediately, the assembly was brought into contact and press to a specular drum of which the surface temperature was held at 100° C., and dried, to produce an ink jet recording sheet. The dry mass of the applied surface layer-wetting coating liquid was 0.5 g/m². The ink fixing agent was contained only in the surface layer.

### Comparative Example 5

An ink jet recording sheet was prepared in a manner similar to that of Example 6, except that the above-mentioned Coating liquid B for the ink-receptive layer (containing an ink fixing agent) and the Surface layer-wetting coating liquid A(without containing any ink fixing agents) were used. The dry mass of the applied surface layer-wetting coating liquid was 0.1 g/m². The ink fixing agent was contained only in the coating liquid for the ink-receptive layer.

### Comparative Example 6

An ink jet recording sheet was prepared in a manner similar to that of Example 6, except that the above-mentioned Surface layer-wetting coating liquid A (without containing any ink fixing agents) was used. The dry mass of the applied surface layer-wetting coating liquid was 0.1 g/m². No ink fixing agent was contained.

### Comparative Example 7

The above-mentioned Coating liquid E for the undercoating layer (without containing any ink fixing agents) was applied on the air-permeable support using an air-knife coater at a dry mass of 6 g/m², and then dried to form an undercoating layer.

On the undercoating layer, the above-mentioned Coating liquid C for the ink-receptive layer (without containing any ink fixing agents) was applied using a die coater at a dry mass of 4 g/m². At this time, the moisture content of the coating layer was 22%. Then, the above-mentioned Surface layer-wetting coating liquid B (containing an ink fixing agent) was applied on the coating layer, and then immediately, the assembly was brought into contact and press to a specular drum of which the surface temperature was held at 100° C., and dried, and thus an ink jet recording sheet was produced. The dry mass of the applied surface layer-wetting coating liquid was 0.6 g/m². The ink fixing agent was contained only in the surface layer-wetting coating liquid.

(Evaluation Method and Evaluation Criteria)

The ink jet recording sheets produced in the above-mentioned examples and comparative examples were evaluated based on the following criteria in terms of the glossiness and the printability at a time of conducting ink jet recording. Results thereof are shown in Tables 1 and 2. In Tables 1 and 2, each content ratio of the ink fixing agent contained in the coating liquid for the undercoating layer, coating liquid for the ink-receptive layer, wetting liquid, or surface layer-wetting coating liquid, existence or absence of the temperature-sensitive polymeric compound in the coating liquid for the ink-receptive layer, the moisture content of the ink-receptive layer before applying the wetting liquid, and the particle diameter of the pigment in the surface layer is also shown.

“Measurement of Moisture Content”

The moisture content of the ink-receptive layer or the surface layer was measured using an infrared moisture gauge KJT-100 (manufactured by KETT ELECTRIC LABORATORY).

“Glossiness”

The glossiness and smoothness of the ink jet recording sheet were evaluated by visually observing the sheet from a lateral direction with respect to the surface of the sheet.
⊚: The sheet showed extremely-high glossiness.
◯: The sheet showed high glossiness.
Δ: The sheet showed glossiness.
×: The sheet slightly lacked glossiness.
   “Ink Jet Recording Properties”
   Printer Used for Evaluation
Printer A: Commercially available dye ink-type ink jet printer (manufactured by SEIKO EPSON CORPORATION., under the trade name of PM-G800)
Printer B; Commercially available pigment ink-type ink jet printer (manufactured by SEIKO EPSON CORPORATION., under the trade name of PX-G900)
   Printing Density

Solid printing of black was conducted using Printer A (dye ink-type), and the printing density was measured using a Macbeth reflection densitometer Macbeth RD-914).

Print Bleeding

Solid colors of black, cyan, magenta, yellow, red green, and blue were printed using Printer A (dye ink-type) in squares where the solid colors were connected to one another along respective boundaries, and the degree of ink-bleeding was visually evaluated at the boundary portions among colors.
◯: Although the printed matter scarcely bled, no practical problems arose.
Δ: The printed matter somewhat bled, and practical problems somewhat arose.
×: The printed matter significantly bled, and serious poetical problems arose.
   Ink Dot Roundness

Halftone printing realizing a low ink-density such that each ink dot was not overlapped was performed using Printer A (dye ink-type), and a halftone printed portion (10% gradation) was enlarged 200 times by an optical microscope to visually observe the shape of the ink-dot.
◯: The shape of the ink dot was round and favorable.
Δ: Although the shape of the ink dot was approximately round, the shape was partially distorted, and was somewhat unfavorable.
×: The shape of the ink dot was not stable and unfavorable.
   Recording Suitability when Using a Pigment Ink

A photographic image (“high-definition color digital standard image (XYZ/SCID) data” in accordance with JIS X 9204, identification symbol of image: N1, name of image: glass and lady) was printed using Printer B (pigment ink-type), and the uniformity at the printed portion was visually evaluated.
⊚: The printed portion was uniform and no uneven print density was recognized, and thus the recording suitability was excellent.
◯: Although uneven print density was scarcely recognized, no practical problems arose.
Δ: Uneven print density was somewhat recognized and practical problems arose somewhat.

×: Uneven print density was recognized, and serious practical problems arose.

TABLE 1

| | Content ratio of ink fixing agent | | | | | | | | | |
|---|---|---|---|---|---|---|---|---|---|---|
| | Coating | Coating | | Temperature- | Moisture | | | | | |
| | liquid for | liquid for | | sensitive | content before | | | | | Pigment |
| | undercoating | ink-receptive | Wetting | polymeric | treatment with | | Printing | Print | | recording |
| | layer | layer | liquid | compound | wetting liquid | Glossiness | density | bleeding | Dot roundness | suitability |
| Example 1 | 0% | 0% | 100% | Presence | 22% | ⊚ | 2.35 | ◯ | ◯ | ⊚ |
| Example 2 | 20% | 0% | 80% | Presence | 23% | ⊚ | 2.32 | ◯ | ◯ | ⊚ |
| Example 3 | 30% | 0% | 70% | Presence | 23% | ⊚ | 2.17 | ◯ | ◯ | ⊚ |
| Comparative | 0% | 100% | 0% | Presence | 22% | ◯ | 2.20 | ◯ | ◯ | ◯ |
| Example 1 | | | | | | | | | | |
| Comparative | 0% | 0% | 0% | Presence | 22% | ◯ | 1.92 | ◯ | ◯ | ⊚ |
| Example 2 | | | | | | | | | | |
| Comparative | 0% | 0% | 100% | Absence | 23% | ◯ | 2.26 | ◯ | X | X |
| Example 3 | | | | | | | | | | |
| Example 4 | 0% | 0% | 100% | Presence | 12% | ◯ | 2.31 | ◯ | ◯ | ◯ |
| Example 5 | 0% | 0% | 100% | Presence | 28% | ⊚ | 2.36 | Δ | ◯ | ⊚ |
| Comparative | 0% | 100% | — | Presence | 23% | Δ | 2.20 | ◯ | ◯ | ◯ |
| Example 4 | | | | | | | | | | |

TABLE 2

| | Content ratio of ink fixing agent | | | | | | | | | |
|---|---|---|---|---|---|---|---|---|---|---|
| | Coating | Coating | | Surface layer | Temperature- | | | | | |
| | liquid for | liquid for | Surface layer- | Pigment | sensitive | | | | | Pigment |
| | undercoating | ink-receptive | wetting | particle | polymeric | | Printing | Print | Dot | recording |
| | layer | layer | coating liquid | diameter (μm) | compound | Glossiness | density | bleeding | roundness | suitability |
| Example 6 | 0% | 0% | 100% | 0.03 | Presence | ⊚ | 2.35 | ◯ | ◯ | ⊚ |
| Example 7 | 20% | 0% | 80% | 0.03 | Presence | ⊚ | 2.30 | ◯ | ◯ | ⊚ |
| Example 8 | 30% | 0% | 70% | 0.03 | Presence | ⊚ | 2.14 | ◯ | ◯ | ⊚ |
| Example 9 | 0% | 0% | 100% | 0.08 | Presence | ◯ | 2.32 | ⊚ | ◯ | ◯ |
| Example 10 | 0% | 0% | 100% | 0.08 | Presence | ⊚ | 2.32 | ⊚ | ◯ | ◯ |
| Example 11 | 0% | 0% | 100% | 0.9 | Presence | ◯ | 2.25 | ◯ | ◯ | ⊚ |
| Example 12 | 0% | 0% | 100% | 0.4 | Presence | ◯ | 2.22 | ◯ | ◯ | ⊚ |
| Example 13 | 0% | 0% | 100% | 0.5 | Presence | ◯ | 2.28 | ◯ | ◯ | ◯ |
| Example 14 | 0% | 0% | 100% | 0.08 | Presence | ⊚ | 2.23 | ◯ | ◯ | ⊚ |
| Example 15 | 0% | 0% | 100% | 0.9 | Presence | ◯ | 2.25 | ◯ | ◯ | ◯ |
| Comparative | 0% | 100% | 0% | 0.05 | Presence | ⊚ | 2.20 | ◯ | ◯ | X |
| Example 5 | | | | | | | | | | |
| Comparative | 0% | 0% | 0% | 0.05 | Presence | Δ | 1.80 | X | X | X |
| Example 6 | | | | | | | | | | |
| Comparative | 0% | 0% | 100% | 0.03 | Absence | X | 2.05 | Δ | X | X |
| Example 7 | | | | | | | | | | |

Each wetting liquid of Examples 1 to 3 contained an ink fixing agent that was a cationic compound, while the wetting liquid of Comparative Example 1 did not contain any cationic compounds. Each ink jet recording sheet produced in Examples 1 to 3 was excellent in all evaluation items, and realized high printing density, and thus a printed image had bright colors. On the other hand, each ink jet recording sheet produced in Comparative Examples 1 and 2, where the wetting liquid did not contain any cationic compounds, did not realize high glossiness and printing density, and thus was inferior in brightness of colors of a printed image.

The ink jet recording sheets produced in Examples 1 to 3 differed in the content of the cationic compound in the wetting liquid. The ink jet recording sheet produced in Example 3, where less than 75% by mass of the cationic compound was provided by the wetting liquid, exhibited a lower printing density than that of the ink jet recording sheets of Examples 1 and 2, and thus was inferior in brightness of colors of a printed image on the ink jet recording sheets of Examples 1 and 2.

Although the ink jet recording sheet produced in Comparative Example 2, where no cationic compound was used, realized favorable recording suitability when a pigment ink was used, the printing density at a time of using a dye ink was the lowest, and the printed image was not bright.

Since the ink jet recoding sheet produced in Comparative Example 3, where no temperature-sensitive polymeric compound was used, could not form the coating surface with high smoothness, the printing density was lower tan that of the ink jet recording sheet of Example 1. Moreover, since the ink-dot roundness was inferior, the printed image was not sharp, and recording suitability when using a pigment ink was also inferior.

The ink jet recording sheets produced in Examples 1 and 4 differed merely in the moisture content before the treatment with the wetting liquid was conducted. It was revealed that the ink jet recording sheet of Example 1, where the moisture content of the ink-receive layer before applying the wetting liquid was greater tan the others, was excellent in glossiness.

The ink jet recording sheets produced in Examples 1 and 5 differed merely in particle diameter of the pigment in the undercoating layer. It was revealed that the ink jet recording sheet of Example 1, where the average particle diameter of the pigment was within a range from 1 to 12 μm, was excellent in preventing print bleeding.

The ink jet recording sheet produced in Comparative Example 4 was produced without using any wetting liquids. It was revealed that the glossiness was not exhibited without using wetting liquid.

Each surface layer-wetting coating liquid used in Examples 6 to 15 contained an ink fixing agent and colloidal particles, while the wetting liquid used in Comparative Example 1 did not contain any wetting liquids. The ink jet recording sheets produced in Examples 6 to 15 were excellent in all evaluation items, and realized high printing density, and thereby the printed image exhibited bright colors. However, the printing density of the ink jet recording sheet produced in Example 8, where less than 75% by mass of the ink fixing agent was provided by the surface layer-wetting coating liquid, was the lowest in the ink jet recording sheets produced in Examples 6 to 15.

On the other hand, the ink jet recording sheet produced in Comparative Example 1, where the surface layer-wetting coating liquid did not contain any ink fixing agents, exhibited uneven print density, and was inferior in recording suitability when using a pigment ink. The ink jet recording sheet produced in Comparative Example 2, where no ink fixing agent was used, exhibited the lowest printing density, significant print bleeding, unstable ink-dot shape, and significantly caused uneven print density, and thus was inferior in recording suitability when using a pigment ink.

The ink jet recording sheet produced in Comparative Example 7, where no temperature-sensitive polymeric compound was used, could not achieve a coating surface with high smoothness was inferior in glossiness, exhibited unstable ink-dot shape, and was inferior in recording suitability when using a pigment ink.

### INDUSTRIAL APPLICABILITY

The ink jet recording sheet according to the present invention exhibits recording suitability when using a dye-type or pigment-type ink jet printer with the aim of realizing conventional photographic image quality, and can realize high printing density to produce bright colors of a printed image, and thus has extremely high practicability.

1. A method for producing an ink jet recording sheet comprising:
applying a coating liquid comprising a temperature-sensitive polymeric compound and a pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity, onto either an air-permeable support or at least one undercoating layer provided on the air-permeable support, in the temperature region where the temperature-sensitive polymeric compound exhibits hydrophobicity, to form a coating layer of the coating liquid;
bringing the temperature of the coating layer to the temperature region where the temperature-sensitive polymeric compound exhibits hydrophilicity to increase the viscosity of the coating layer or gelate the coating layer;
applying a wetting liquid comprising an ink fixing agent onto the viscosity-increased or gelated coating layer; and
bringing the resulting assembly into contact with a heated specular surface and drying to form an ink-receptive layer.

2. A method for producing an ink jet recording sheet according to claim 1, wherein at least 75% by mass of the whole ink fixing agent contained in the ink jet recording sheet is provided by the wetting liquid.

3. A method for producing an ink jet recording sheet according to claim 1 or 2, wherein a moisture content of the coating layer at a time of applying the wetting liquid is greater than or equal to 12% by mass.

4. A method for producing an ink jet recording sheet according to claim 1, wherein the undercoating layer is provided on the air-permeable support and the undercoating layer comprises a pigment having an average particle diameter of 1 to 12 μm.

5. A method for producing an ink jet recording sheet according to claim 1, wherein the ink fixing agent contained in the wetting liquid comprises at least one selected from the group consisting of a diallyl dimethyl ammonium chloride polymer, a diallyl dimethyl ammonium chloride-acrylamide copolymer, a hydrochloride salt of an acrylamide-diallylamine copolymer, a dicyandiamide-polyethyleneamine copolymer, and a cationic resin having a five-membered amidine structure.

6. A method for producing an ink jet recording sheet comprising:
applying a coating liquid comprising a temperature-sensitive polymeric compound and a pigment, the temperature-sensitive polymeric compound having a temperature region where the temperature-sensitive polymeric compound exhibits hydrophobicity and a temperature region where the temperature-sensitive polymeric compound exhibits hydrophilicity, the coating liquid becoming more viscous or gelating in the temperature region where the temperature-sensitive polymeric compound exhibits hydrophilicity, onto either an air-permeable support or at least one undercoating layer provided on the air-permeable support, in the temperature region where the temperature-sensitive polymeric compound exhibits hydrophobicity, to form a coating layer of the coating liquid;
bringing the temperature of the coating layer to the temperature region where the temperature-sensitive polymeric compound exhibits hydrophilicity to increase the viscosity of the coating layer or gelate the coating layer;
drying to form an ink-receptive layer;
applying a surface layer-wetting coating liquid comprising colloidal particles and an ink fixing agent onto the ink-receptive layer;
bringing the resulting assembly into contact with a heated specular surface and drying to form a surface layer.

7. A method for producing an ink jet recording sheet according to claim 6, wherein at least 75% by mass of the whole ink fixing agent contained in the ink jet recording sheet is provided by the surface layer-wetting coating liquid.

8. A method for producing an ink jet recording sheet according to claim 6 or 7, wherein the ink fixing agent contained in the surface layer-wetting coating liquid comprises at least one selected from the group consisting of a diallyl dimethyl ammonium chloride polymer, a diallyl dimethyl ammonium chloride-acrylamide copolymer, a hydrochloride salt of an acrylamide-diallylamine copolymer, a dicyandiamide-polyethyleneamine copolymer, and a cationic resin having a five-membered amidine structure.

9. A method for producing an ink jet recording sheet according to claim 6, wherein the colloidal particles contained in the surface layer-wetting coating liquid are at least one selected from the group consisting of a monodispersed colloidal pigment having an average primary particle diameter of 0.01 to 0.06 μm, an alumina having an average secondary particle diameter of 1 μm or less, an alumina hydrate having an average secondary particle diameter of 1 μm or less, a fumed silica having an average secondary particle size of 0.7 μm or less, and a wet silica gel having an average secondary particle size of 0.5 μm or less.

10. A method for producing an ink jet recording sheet according to claim 6, wherein the colloidal particles contained in the surface layer-wetting coating liquid are cationic colloidal silica.

11. An ink jet recording sheet by comprising:
an ink-receptive layer formed on either an air-permeable support or at least one undercoating layer formed on the air-permeable support, the ink-receptive layer comprising a temperature-sensitive polymeric compound having a temperature region where the temperature-sensitive polymeric compound exhibits hydrophobicity and a temperature region where the temperature-sensitive polymeric compound exhibits hydrophilicity, a pigment, and an ink fixing agent, wherein the content of the ink fixing agent decreases from a surface-side of the ink-receptive layer to an air-permeable support-side of the ink-receptive layer.

12. An ink jet recording sheet according to claim 11, further comprising a surface layer provided on the ink-receptive layer, the surface layer comprising an ink fixing layer and colloidal particles.
